(19) United States
(12) Patent Application Publication
(10) Pub. No.: US 2021/0299528 A1
(43) Pub. Date: Sep. 30, 2021

(54) GOLF CLUB CARRIER

(71) Applicant: Andrew LOGAN, Auckland (NZ)

(72) Inventor: Andrew LOGAN, Auckland (NZ)

(21) Appl. No.: 17/261,596

(22) PCT Filed: Jul. 24, 2019
(86) PCT No.: PCT/IB2019/056308

§ 371 Date: Jan. 20, 2021

(30) Foreign Application Priority Data
Jul. 24, 2018 (NZ) 744581

(51) Int. Cl. A63B 55/30; A63B 55/00; B62B 3/12; B62B 3/02

(52) U.S. Cl. CPC A63B 55/30; A63B 55/408; A63B 55/60; B62B 3/022; A63B 55/406; B62B 3/12

(57) ABSTRACT

A golf club carrier (100) comprising an elongate body (102) and a trundler mechanism (120) is disclosed. The trundler mechanism (120) is configured to be attached to the elongate body (102). The trundler mechanism (120) comprises a track (119a, 119b), at least one slidable collar (118) mounted to the track (119a, 119b), and at least two struts (122, 124) that are mounted to the collar (118). The trundler mechanism (120) is reconfigurable between a stowed or collapsed condition and a deployed condition without requiring any assembly or disassembly of the trundler mechanism (120). In the deployed condition, one of the ends of each strut (122, 124) extend away from the elongate body (102) and the wheels (132, 134) can be secured to the struts (122, 124) to allow the carrier (100) to be transported in a rolling manner over ground.

### FIELD OF THE INVENTION

The present invention relates to a golf club carrier. More particularly, but not exclusively, the present invention relates to a golf club carrier that can also act as a trundler.

### BACKGROUND OF THE INVENTION

Golf is a popular sport enjoyed by people of all ages around the world. Golf club carriers are commonly used by golfers to carry and transport their golf equipment and supplies. Ease of portability of such carriers may be desired as golfers often walk great distances across golf courses. Golf club carriers may come in the form of carry bags that can be slung over the shoulders of a golfer for him/her to carry. The bags may also be mounted/secured to a separate push cart, trundler or trolley to allow them to be wheeled over ground.

Golf bags mounted/secured to a push cart, trundler or trolley may be beneficial for transporting generally heavy golf equipment and supplies around golf courses with relative ease. Golf bags can so be easily transported and may allow golfers to minimise strain and other injuries and to improve their golfing experience.

Using a push cart, trundler or trolleys to carry the golf club bag may be one option to facilitate easy transport. However, simply using a trolley may still not be a best solution as the user will now need to carry, store and transport two, sometimes three separate items namely, the trolley, the golf club bag and the wheels. Another option may be to have a golf club bag comprising a trundler that could be removably attached to the golf club bag. This is shown in U.S. Pat. No. 2,619,360A. However, a problem still exists in relation to the storage and transportation of the golf club bags. With the presence of wheels and the frame of the trundler mechanism the overall volume of such a golf club carrier increases and consequently those designs are not desirable when it comes to carrying, transportation and storage. Further, such mechanism may require assembling and disassembling which can be a tedious and a time-consuming exercise.

Further, if golfers chose to utilise a driveable motorised golf cart to transport their bags whilst playing, the golf club carrier would need to resemble the shape and form of a standard golf bag to be able to be strapped onto the back of the driveable motorised golf cart. A golf club carrier that converts from a bag and trundler combination to a bag may be desirable.

Also, finding a suitable and convenient place for storage of the wheels and the struts in a compact and preferably obscured manner, is a problem that is faced by golfers. Typically, these detachable wheels are stored in a separate bag or container adding to the burden of golfers when travelling or transporting their equipment and increases the chances of the loss of equipment or forgetting to take the wheels to the course.

Golfers commonly make use of air travel to play golf on different courses and are presented with luggage limitations when flying. In most cases they are forced to leave a trundler behind as it is a large, heavy piece of additional luggage, often incurring additional airline fees. This presents a problem when travelling as golfers are either forced to pay additional luggage fees or are required to pay to hire a trundler from the courses being played.

A golf club carrier with a permanently attached folding trundler mechanism where the carrier provides storage space for at least the wheels may be desired. Also, a golf club carrier that may include a permanently attached trundler mechanism may be desired to be presented as a golf club bag by the owner, without showing the trundler components.

Also, finding a suitable and convenient place for storage of both the wheels and the struts in a compact and preferably obscured manner, is a problem that is faced by the golfers.

One of the problems with previously known golf club carriers is that their look (e.g. colour, branding) and/or feel cannot be easily be changed according to the taste of the user. Similarly, the functional features such as water resistance ability of the traditional golf club carrier cannot be changed without replacing the golf club carriers.

### OBJECT OF THE INVENTION

It is an object of the present invention to provide a golf club carrier which overcomes or at least partially ameliorates some of the abovementioned disadvantages or which at least provides the public with a useful choice.

### SUMMARY OF THE INVENTION

According to a first aspect the invention broadly resides in a golf club carrier comprising:

an elongate body extending in an elongate direction and having a first end and a second end, the elongate body comprising at least one golf club receiving compartment adapted to receive golf clubs from the first end,

a trundler mechanism attached or for attaching to the elongate body, the trundler mechanism comprising:
i. a track extending in the elongate direction (preferably parallel to the elongate direction);
ii. at least one slide (preferably a slidable collar) slidably mounted to the track and adapted to slide along the track in the elongate direction (preferably parallel to the elongate direction) of the elongate body between a first position and a second position; and
iii. at least two struts each having a proximal end and a distal end, the proximal ends of each strut being mounted to the slide and/or the track in a manner to be able to pivot relative to the track; and

wherein trundler mechanism is reconfigurable between (a) a stowed condition where each strut is positioned with its distal end proximal the elongate body when the slide is in the first position and (b) a deployed condition when the slide is in the second position where each strut is presented with its distal end more distal from the elongate body than when in the stowed condition in a manner extending from the proximal end away from the elongate body, each strut able to receive and secure a wheel at or near the distal end of each strut to allow the carrier to be transported in a rolling manner over ground.

Preferably, the golf club carrier further comprises a storage compartment that is configured to stow the trundler mechanism, the storage compartment being presented adjacent the elongate body, wherein:
in the stowed condition of the trundler mechanism, the struts are positioned to locate in the storage compartment, and
in the deployed condition of the trundler mechanism each of the struts are presented extending, out of the storage compartment (preferably from the slide in the storage compartment), in a manner extending away from the elongate body.

Preferably, the struts are configured to move pivotally relative the slide and/or track when the trundler mechanism reconfigures between the stowed condition to the deployed condition.

Preferably, the elongate body is of a unitary construction.

Preferably, the struts are parallel to each other in the stowed condition.

Preferably, the struts are splay away from each other in the deployed condition from their proximal ends.

Preferably, the storage compartment is presented adjacent the elongate body on an external surface of the elongate body.

Preferably, the storage compartment is integrally formed with the elongate body.

Preferably, the trundler mechanism is permanently attached to the elongate body.

Preferably, the track comprises two spaced apart and parallel rails and the at least one slide is adapted to slide along the rails between its first and second positions in the elongate direction of the elongate body.

Preferably, the track comprises two spaced apart and parallel rails and the at least one slide is adapted to slide along the rails between its first and second positions in a direction parallel to the elongate direction of the elongate body.

Preferably, the at least one slide is configured to releasably lock to the track by a locking mechanism.

Preferably, the struts are adjustable in length.

Preferably, the carrier is configured to be supported above the ground by at least two wheels.

Preferably, wherein the trundler mechanism further comprises a wheel attachment and support mechanism dependent from the elongate body and having a proximal end and a distal end.

Preferably, the wheel attachment and support mechanism is configured to be move (preferably pivoted) between (a) a stowed condition where the wheel attachment and support mechanism is located more proximal the elongate body and (b) a deployed condition where the wheel attachment and support mechanism is presented in a manner extending from the elongate body with its distal end at a position that is more distal the elongate body than in the stowed condition, and in a manner to be able to receive and secure a wheel that, in cooperation with the first and second mentioned wheels, allow the carrier to be rolled over ground.

Preferably, wherein: (a) in the stowed condition of the wheel attachment and support mechanism, the wheel attachment and support mechanism is positioned proximal the elongate body and preferably substantially or entirely located in the storage compartment, and
(b) in a deployed condition of the wheel attachment and support mechanism, the wheel attachment and support mechanism is presented in a manner extending away from the elongate body with its proximal end at or more proximal or adjacent the storage compartment and its distal end at a position that is more distal the storage compartment and elongate body than when in the stowed condition.

Preferably, the wheel attachment and support mechanism comprises a fork comprising two spaced apart and parallel arms and the at least one wheel is able to be received and secured between the two arms of the fork.

Preferably, the wheel attachment and support mechanism is a front wheel attachment and support mechanism.

Preferably, the golf club carrier is configured to be supported above the ground by three wheels.

Preferably, the three wheels comprises two rear wheels configured to be received and secured by the struts and a front wheel configured to be received and secured by the wheel attachment and support mechanism.

Preferably, elongate body comprises a wheel compartment configured to store at least two wheels that are configured to support the carrier on the ground, the wheel compartment being located at the second end of the elongate body.

Preferably, the at least one golf club compartment extends to the wheel compartment, and preferably into and/or through the wheel compartment.

Preferably, the at least two wheels at least partially nest with each other when stored inside the wheel compartment.

Preferably, the struts move pivotally with respect to the slide between the stowed and deployed condition.

Preferably, the at least two wheels are able to releasably couple together (preferable in a partially nested manner) in a co-axial manner for storage inside the wheel compartment.

Preferably, at least one of the at least two wheels comprises at least one protrusion formed on at least one side of its rim, the at least one protrusion of said at least one wheel being configured to be received by at least one complementary feature formed on the rim of the other for the releasable coupling of the at least two wheels.

Preferably, at least one of the at least two wheels comprises a plurality of protrusions formed on at least one side of its rim, the protrusions of said at least one wheel being configured to be received by a plurality of complementary feature formed on the rim of the other for the releasable coupling of the at least two wheels.

Preferably, the complementary features are notches or grooves that are sized and shaped to receive the protrusions.

Preferably, each of the at least two wheels comprises spokes and the spokes of the at least two wheels are aligned when the at least two wheels are coupled together.

Preferably, the wheel compartment is configured to store three wheels in a coaxial manner.

Preferably, the at least two of the three wheels at least partially nest with the third wheel when stored inside the wheel compartment.

Preferably, the golf club carrier further comprises a brake system to slow or stop the golf club carrier rolling over ground.

Preferably, the brake system comprises a pin able to engage with part of at least one of said wheels to prevent the wheel from continuously rotating.

Preferably at least one of the wheels comprises a plurality of holes preferably on its rim, wherein in use the pin is adapted to be received by one of the plurality of holes thereby causing to slow or stop the golf club carrier rolling over ground.

Preferably, the brake system is a cable brake system comprising a brake handle that is operatively connected to a brake pad by a cable so that when the brake handle is a first position a tension is caused in the cable that allows the brake pad to engage with at least one of the wheels, or with an external tread of said at least one of the wheels thereby to slow or stop the golf club carrier rolling over ground.

Preferably, said at least one of the wheels is a front wheel.

Preferably, at least one of the wheels is the at least one wheel that is configured to be received or secured by the wheel attachment and support mechanism.

Preferably, wherein when the brake handle is in a first position the brake handle is more visible than when it is a second position that corresponds to the brake pad being released from the at least one of the wheels, or with an external tread of said at least one of the wheels thereby not to slow or stop the golf club carrier rolling over ground.

Preferably, wherein the brake handle is shaped (presented as) as a flag that is of a colour that is visible from a distance when in its first position.

Preferably, the trundler mechanism further comprises at least one and preferably two brace members, the or each brace member having a first and second end, the first end of the or each brace member is pivotally secured with each or a respective said strut and the second end of the or each brace member is pivotally secured relative the elongate body.

Preferably, the second end of the or each brace member is pivotally secured to the elongate body.

Preferably, the second end of the or each brace member is pivotally secured to the elongate body at or proximate the second end of the elongate body.

Preferably the first end of the or each brace member is pivotally secured to a respective strut intermediate of the proximal and distal end of each strut.

Preferably the first end of the or each brace member is pivotally secured to a respective strut proximal the mid-point of each strut.

Preferably the first end of the or each brace member is pivotally secured more proximate the proximal end of a respective strut.

Preferably the first end of the or each brace member remains at a fixed distance to the proximal end the strut it is secured to.

Preferably the first end of the or each brace member remains at a fixed distance to the distal end the strut it is secured to.

Preferably the proximal end of the or each strut is able to translate relative the second end of the brace member that it is secured to.

Preferably the proximal end of the or each strut is able to translate relative the elongate body and to the second end of the brace member that it is secured to.

Preferably, each strut is coupled to the elongate body by a brace member that extends between the elongate body and the strut, intermediate of the proximal and distal ends of the strut, so that each strut and brace member can move relative the elongate body as a slider crank mechanism.

Preferably, the trundler mechanism comprises at least two brace members, each brace member being secured or adapted to be secured to one of the struts with each strut secured or adapted to be secured with one brace member only.

Preferably, the brace member comprises a first end and a second end, the first end of each brace member is secured or adapted to be secured to one of the struts with each strut secured or adapted to be secured with one brace member only, and wherein the second ends of the brace members are secured or adapted to be secured with the or a wheel attachment and support mechanism or the track or secondary slide that is slidably mounted to the track and/or elongate body to move relative the elongate body in the elongate direction.

Preferably the second ends of the brace members are secured or adapted to be secured with the or a wheel attachment and support mechanism or the track or a secondary slide that is slidably mounted to the track and/or elongate body to move relative the elongate body in the elongate direction.

Preferably the wheel attachment and support mechanism is attached to the secondary slide.

Preferably the wheel attachment and support mechanism is pivotally attached to the secondary slide.

Preferably the wheel attachment and support mechanism translates with the secondary slide as it moves relative the elongate body.

Preferably the secondary slides moves between a first and second position relative the elongate body, the first position corresponding to the first position of the slide and the second position corresponding to a position of the slide intermediate of its first and second positions.

Preferably first and second positions of the secondary slide are defined by stops.

Preferably, the slide (collar) first moves from the first position to the second position and the secondary slide then moves from its first position to second position, keeping the struts proximal to the elongate body, and when the secondary slide reaches its second position the movement of the secondary slide stops while the slide continues to move to its second position whereupon the struts start to move to their deployed condition as the slide is moved towards the secondary slide.

Preferably, the slide (collar) first moves from the first position to the second position and the secondary slide then moves from its first position to second position, keeping the separation of the slide and secondary slide the same.

Preferably, in the first position of the slide, the slide is more proximal to the first end of the elongate body that in its second position.

Preferably, in the first position of the secondary slide, the secondary slide is more proximal to the first end of the elongate body that in its second position.

Preferably, the secondary slide moves from its first position to its second position, by moving the slide from the first position to the second position.

Preferably, the track comprises two parallel spaced apart rails and the secondary slide is connected to and spans the two rails.

Preferably, the track comprises two parallel spaced apart rails and the secondary slide is a U-shaped member telescopically connected to the two rails as ends of the rails proximal the second end of the elongate body.

Preferably, the proximal end of each strut is able to translate relative the elongate body and to the second end of the brace member that it is secured to, the second end of the brace member also able to translate relative the elongate body.

Preferably, the brace members are rods or tubes.

Preferably, the first end of each of the brace member is secured or adapted to be secured to the struts via fixed or removable securing arrangement and the mounting of the second ends of the brace members are via pivotal, hinged or slidable arrangement.

Preferably, the storage compartment terminates at a distance on the first end side of the second end of the elongate body.

Preferably, the golf club carrier comprises a storage compartment lid for closing the storage compartment to conceal and enclose the trundler mechanism inside the storage compartment when in its stowed condition and which when open reveals the trundler mechanism.

Preferably, the storage compartment lid is pivotally mounted relative to (and preferably to) the elongate body.

Preferably, the storage compartment lid comprises a pocket suitable for storing of one or more items.

Preferably, the storage compartment lid comprises a cavity or recess for holding a bottle.

Preferably, the storage compartment lid comprises a gripping portion that is adapted to facilitate gripping by at least one hand of a user.

Preferably, the storage compartment lid doubles as a handle for pushing, pulling and controlling the direction of the golf club carrier when transported in a rolling manner over the ground.

Preferably, there is provided a handle for pushing, pulling and controlling the direction of the golf club carrier when transported in a rolling manner over the ground.

Preferably, the handle doubles as the storage compartment lid as herein described.

Preferably, the handle can move between a condition parallel the elongate body and a condition for use presented in a position rotated more than 90 degrees from its condition parallel.

Preferably, the compartment lid can move between a condition parallel the elongate body when in the closed position and a condition for use presented as a handle in a position rotated more than 90 degrees from its closed position.

Preferably, the angle of the storage compartment lid can be adjusted and set relative to the elongate direction.

Preferably, the angle of the handle or lid is able to have its angle of set adjusted.

Preferably, the gripping portion includes a button that when depressed allows the angle storage compartment lid, or both to be adjusted upwards or downwards.

Preferably, release of the button causes the angle to be set or locked.

Preferably, at least one handle is mounted/secured or formed on the exterior of the elongate body as a body handle.

Preferably the struts are pivotally mounted relative the elongate body.

Preferably the struts are pivotally mounted relative the or each respective collar.

Preferably, the trundler mechanism comprises at least two brace members, each brace member extending between a first end and a second end, the first end of each brace member is mounted/secured or adapted to be mounted/secured to one of the struts (preferably with each strut mounted/secured or adapted to be mounted/secured with one brace member only), and wherein the second ends of the brace members are mounted/secured or adapted to be mounted/secured with the elongate body, or the wheel attachment and support mechanism, or the rails.

Preferably, the first end of each of the brace member is mounted/secured or adapted to be mounted/secured to the struts (preferably at or near the distal end of each strut) via fixed or removable arrangement and the mounting of the second ends of the brace members are via pivotal, hinged or slidable arrangement.

Preferably the collar is at or nearer the first end of the elongate body when the struts are in their stowed condition and are more proximal the second end of the elongate body when the struts are in their deployed condition.

Preferably, the golf club carrier comprises a storage compartment lid (preferably pivotally mounted to the elongate body) which when closed conceals/encloses the storage compartment and which when open reveals the storage compartment.

Preferably, the storage compartment does not extend to the second end of the elongate body.

Preferably, the distance between the second end of the elongate body and the storage compartment is greater than 50 mm.

Preferably, the distance between the second end of the elongate body and the storage compartment is greater than 100 mm.

Preferably, the length and the shape of the elongate body remains unaffected/unchanged by the presence of the trundler mechanism.

Preferably, the storage compartment lid comprises a pocket (preferably made out of plastic material or mesh) suitable for storage of items such as but not limited to golf balls, mobile phones, wallets and score cards.

Preferably, the storage compartment lid comprises a cavity to hold a water or drinks bottle.

Preferably, the storage compartment lid comprises a gripping portion (or handle) that is adapted to facilitate gripping by hand(s) of a user.

Preferably, the storage compartment lid comprises a flat surface portion.

Preferably, at least one handle is mounted/secured or formed (preferably integrally formed) on the exterior of the elongate body.

Preferably, at least one handle is located at the storage compartment, the at least one handle being able to be moved from the stored condition adjacent/in/parallel the storage compartment and deployed condition extending away and preferably upwards (when the trundler is in use) from the elongate body.

Preferably, the gripping portion (or handle) contains a button which when depressed allows the angle of the handle, storage compartment lid, or both to be adjusted upwards or downwards.

Preferably, the wheel compartment lid and/or the storage compartment lid is/are pivotable about an axis that is orthogonal to longitudinal axis of the elongate body.

Preferably, in the deployed condition, the struts are angled less than 90 degrees (preferably between 30 degrees and 75 degrees) from the elongate body.

Preferably, in the deployed condition the brace members are mounted/secured or adapted to be mounted/secured to the struts in such a way that the angle between the elongate body and each of the brace members are less than 90 degrees.

Preferably, in the deployed condition the elongate body is tilted at an angle (preferably at least 40 degrees) from horizontal.

Preferably, in use, the elongate body is supported above the ground by three wheels.

Preferably in use, the line of roll of the two wheels supported by the two struts are on each side of the line of roll of the third or front wheel.

Preferably in use, the line of roll of the third or front wheel lies in a plane that also passes through the elongate direction axis of the elongate body.

Preferably the three wheels contact the ground at three points each at an apex of a notional triangle.

Preferably the third or front wheel is mounted/secured, in use, as an idler wheel.

Preferably when deployed the axis of rotation of the strut mounted/secured wheels are coaxial.

Preferably, the three wheels support the elongate body above a horizontal or substantially horizontal surface at an incline of between 40 and 90 degrees (more preferably 45 degrees) to the horizontal or the substantially horizontal surface.

Preferably, in use, the wheels that are received and secured at the distal ends of the struts are away from the elongate body more and side of centreline travel direction and the wheel received and secured at the distal end of the wheel attachment and support mechanism is close to elongate body and preferably on centreline of travel.

Preferably, the elongate body comprises a wheel compartment configured to store at least two wheels and preferably three wheels inside the wheel compartment, the wheel compartment being located (preferably integrally formed) at a bottom region of the elongate body that is proximal to the second end.

Preferably, the elongate body comprises a wheel compartment lid (preferably pivotally mounted to the elongate body) which when closed fully conceals/encloses the wheel compartment at the bottom region and which when open reveals the storage compartment thereby providing access to the storage compartment from the bottom region.

Preferably, the elongate body comprises a separator for separating the at least one golf club receiving compartment from the wheel compartment.

Preferably, the separator is formed by at least one golf club storage compartment.

Preferably, each of the wheels have one or more through openings and the separator is of the shape that complements the shape of at least some of the openings of each wheel to allow the separator to project into the one or more through openings of the wheels when the wheels are stored in the wheel compartment, and to accommodate at least one golf club in such a manner that a club handle of the at least one golf club can locate in one of the through openings of the at least one wheel without coming into contact with the wheels.

Preferably, when stored in the wheel compartments the wheels are biased for movement in a direction towards the base (by way of gravity and/or biasing means).

Preferably, the separator is configured to allow the club handle of the golf club to locate at the openings of each wheel without said at least one golf club coming into contact with said wheels.

Preferably, at least two of the wheels nest (at least partially nest) inside each other when stored inside the wheel compartment.

Preferably, the length of each strut is no longer than 550 mm.

Preferably, the length of each strut is 471 mm (or about 471 mm).

Preferably, the length of each brace member is no longer than 400 mm.

Preferably, the length of each brace member is 315 mm (or about 315 mm).

Preferably, the length of the elongate body from the first end to second end is no longer than 1000 mm.

Preferably, the length of the elongate body from the first end to second end is 902 mm (or about 902 mm).

Preferably, the length of the wheel compartment is 230 mm from the second compartment.

Preferably, the elongate body is circular or substantially circular in cross-section in an axis that is orthogonal to the length of the elongate body.

Preferably, the elongate body is polygonal in cross-section in an axis that is orthogonal to the length of the elongate body.

Preferably, the elongate body is made from plastic, polyvinyl chloride (PVC), polyethylene or a combination thereof.

Preferably, the two rails are attached or integrally formed with a secondary slide (preferably a U-shaped member) at or near the bottom.

Preferably, the end of the wheel attachment and support mechanism that is proximal to the elongate body is pivotally mounted to the secondary slide or U-shaped member.

Preferably, the secondary slide or U-shaped member is part of the wheel attachment and support mechanism.

Preferably, each brace member extends between the secondary slide or U-shaped member (secondary slide) and the respective struts.

Preferably, the brace members are elongate members such as rods or tubes.

Preferably, the brace members in the stored condition are parallel each other and preferably parallel to the elongate direction of the elongate body.

Preferably, the brace members at their proximal end are attached to the elongate body and at their distal end are attached to the respective strut.

Preferably, the brace members are pivotally mounted to a respective strut.

Preferably, the brace members are mounted/secured to a respective strut intermediate of the ends of the strut.

Preferably, the brace members are not translationally mounted/secured to said elongate body.

Preferably, the brace members are translationally mounted/secured to said elongate body.

Preferably, the brace members are not translationally mounted/secured to a respective said strut.

Preferably, the brace members are translationally mounted/secured to a respective said strut.

According to a second aspect, the invention resides in a golf club carrier comprising:

an elongate body extending in an elongate direction and having a first end and a second end, the elongate body comprising at least one golf club receiving compartment adapted to receive golf clubs from the first end,

a trundler mechanism attached or for attaching to the elongate body, the trundler mechanism comprising:
i. a track extending in the elongate direction (preferably parallel to the elongate direction);
ii. at least one slide (preferably a slidable collar) slidably mounted to the track and adapted to slide along the track in the elongate direction (preferably parallel to the elongate direction of the elongate body between a first position and a second position; and
iii. at least two struts each having a proximal end and a distal end, the proximal ends of each strut being mounted to the slide and/or the track in a manner to be able to pivot relative to the track; and

wherein trundler mechanism is reconfigurable between (a) a stowed condition where each strut is positioned with its distal end proximal the elongate body when the slide is in the first position and (b) a deployed condition when the slide is in the second position where each strut is presented with its distal end more distal from the elongate body than when in the stowed condition in a manner extending from the proximal end away from the elongate body, each strut able to receive and secure a wheel at or near the distal end of each strut to allow the carrier to be transported in a rolling manner over ground,

wherein the elongate body comprises a wheel compartment located at the second end of the elongate body and configured to store said wheels.

Preferably the carrier comprises at least two wheels.

Preferably the at least two wheels are able to releasably couple together (preferable in a partially nested manner) in a co-axial manner for storage inside the wheel compartment.

Preferably, the golf club carrier further comprises a storage compartment that is configured to stow the trundler mechanism, the storage compartment being presented adjacent the elongate body, wherein:

in the stowed condition of the trundler mechanism, the struts are positioned to locate in the storage compartment, and

in the deployed condition of the trundler mechanism each of the struts are presented extending, out of the storage compartment (preferably from the slide in the storage compartment), in a manner extending away from the elongate body.

Preferably, the struts are configured to move pivotally relative the slide and/or track when the trundler mechanism reconfigures between the stowed condition to the deployed condition.

Preferably, the elongate body is of a unitary construction.

Preferably, the struts are parallel to each other in the stowed condition.

Preferably, the struts are splay away from each other in the deployed condition from their proximal ends.

Preferably, the storage compartment is presented adjacent the elongate body on an external surface of the elongate body.

Preferably, the storage compartment is integrally formed with the elongate body.

Preferably, the trundler mechanism is permanently attached to the elongate body.

Preferably, the track comprises two spaced apart and parallel rails and the at least one slide is adapted to slide along the rails between its first and second positions in the elongate direction of the elongate body.

Preferably, the track comprises two spaced apart and parallel rails and the at least one slide is adapted to slide along the rails between its first and second positions in a direction parallel to the elongate direction of the elongate body.

Preferably, the at least one slide is configured to releasably lock to the track by a locking mechanism.

Preferably, the struts are adjustable in length.

Preferably, the carrier is configured to be supported above the ground by at least two wheels.

Preferably, wherein the trundler mechanism further comprises a wheel attachment and support mechanism dependent from the elongate body and having a proximal end and a distal end.

Preferably, the wheel attachment and support mechanism is configured to be move (preferably pivoted) between (a) a stowed condition where the wheel attachment and support mechanism is located more proximal the elongate body and (b) a deployed condition where the wheel attachment and support mechanism is presented in a manner extending from the elongate body with its distal end at a position that is more distal the elongate body than in the stowed condition, and in a manner to be able to receive and secure a wheel that, in cooperation with the first and second mentioned wheels, allow the carrier to be rolled over ground.

Preferably, wherein: (a) in the stowed condition of the wheel attachment and support mechanism, the wheel attachment and support mechanism is positioned proximal the elongate body and preferably substantially or entirely located in the storage compartment, and
(b) in a deployed condition of the wheel attachment and support mechanism, the wheel attachment and support mechanism is presented in a manner extending away from the elongate body with its proximal end at or more proximal or adjacent the storage compartment and its distal end at a position that is more distal the storage compartment and elongate body than when in the stowed condition.

Preferably, the wheel attachment and support mechanism comprises a fork comprising two spaced apart and parallel arms and the at least one wheel is able to be received and secured between the two arms of the fork.

Preferably, the wheel attachment and support mechanism is a front wheel attachment and support mechanism.

Preferably, the golf club carrier is configured to be supported above the ground by three wheels.

Preferably, the three wheels comprises two rear wheels configured to be received and secured by the struts and a front wheel configured to be received and secured by the wheel attachment and support mechanism.

Preferably, elongate body comprises a wheel compartment configured to store at least two wheels that are configured to support the carrier on the ground, the wheel compartment being located at the second end of the elongate body.

Preferably, the at least one golf club compartment extends to the wheel compartment, and preferably into and/or through the wheel compartment.

Preferably, the at least two wheels at least partially nest with each other when stored inside the wheel compartment.

Preferably, the struts are parallel to each other in the stowed condition.

Preferably, the struts move pivotally with respect to the slide between the stowed and deployed condition.

Preferably, the at least two wheels are able to releasably couple together (preferable in a partially nested manner) in a co-axial manner for storage inside the wheel compartment.

Preferably, at least one of the at least two wheels comprises at least one protrusion formed on at least one side of its rim, the at least one protrusion of said at least one wheel being configured to be received by at least one complementary feature formed on the rim of the other for the releasable coupling of the at least two wheels.

Preferably, at least one of the at least two wheels comprises a plurality of protrusions formed on at least one side of its rim, the protrusions of said at least one wheel being configured to be received by a plurality of complementary feature formed on the rim of the other for the releasable coupling of the at least two wheels.

Preferably, the complementary features are notches or grooves that are sized and shaped to receive the protrusions.

Preferably, each of the at least two wheels comprises spokes and the spokes of the at least two wheels are aligned when the at least two wheels are coupled together.

Preferably, the wheel compartment is configured to store three wheels in a coaxial manner.

Preferably, the at least two of the three wheels at least partially nest with the third wheel when stored inside the wheel compartment.

Preferably, the golf club carrier further comprises a brake system to slow or stop the golf club carrier rolling over ground.

Preferably, the brake system comprises a pin able to engage with part of at least one of said wheels to prevent the wheel from continuously rotating.

Preferably at least one of the wheels comprises a plurality of holes preferably on its rim, wherein in use the pin is adapted to be received by one of the plurality of holes thereby causing to slow or stop the golf club carrier rolling over ground.

Preferably, the brake system is a cable brake system comprising a brake handle that is operatively connected to a brake pad by a cable so that when the brake handle is a first position a tension is caused in the cable that allows the brake pad to engage with at least one of the wheels, or with an external tread of said at least one of the wheels thereby to slow or stop the golf club carrier rolling over ground.

Preferably, said at least one of the wheels is a front wheel.

Preferably, at least one of the wheels is the at least one wheel that is configured to be received or secured by the wheel attachment and support mechanism.

Preferably, wherein when the brake handle is in a first position the brake handle is more visible than when it is a second position that corresponds to the brake pad being released from the at least one of the wheels, or with an external tread of said at least one of the wheels thereby not to slow or stop the golf club carrier rolling over ground.

Preferably, wherein the brake handle is shaped (presented as) as a flag that is of a colour that is visible from a distance when in its first position.

Preferably, the trundler mechanism further comprises at least one and preferably two brace members, the or each brace member having a first and second end, the first end of the or each brace member is pivotally secured with each or a respective said strut and the second end of the or each brace member is pivotally secured relative the elongate body.

Preferably, the second end of the or each brace member is pivotally secured to the elongate body.

Preferably, the second end of the or each brace member is pivotally secured to the elongate body at or proximate the second end of the elongate body.

Preferably the first end of the or each brace member is pivotally secured to a respective strut intermediate of the proximal and distal end of each strut.

Preferably the first end of the or each brace member is pivotally secured to a respective strut proximal the mid-point of each strut.

Preferably the first end of the or each brace member is pivotally secured more proximate the proximal end of a respective strut.

Preferably the first end of the or each brace member remains at a fixed distance to the proximal end the strut it is secured to.

Preferably the first end of the or each brace member remains at a fixed distance to the distal end the strut it is secured to.

Preferably the proximal end of the or each strut is able to translate relative the second end of the brace member that it is secured to.

Preferably the proximal end of each strut is able to translate relative the elongate body and to the second end of the brace member that it is secured to.

Preferably, each strut is coupled to the elongate body by a brace member that extends between the elongate body and the strut, intermediate of the proximal and distal ends of the strut, so that each strut and brace member can move relative the elongate body as a slider crank mechanism.

Preferably, the trundler mechanism comprises at least two brace members, each brace member being secured or adapted to be secured to one of the struts with each strut secured or adapted to be secured with one brace member only.

Preferably, the brace member comprises a first end and a second end, the first end of each brace member is secured or adapted to be secured to one of the struts with each strut secured or adapted to be secured with one brace member only, and wherein the second ends of the brace members are secured or adapted to be secured with the or a wheel attachment and support mechanism or the track or secondary slide that is slidably mounted to the track and/or elongate body to move relative the elongate body in the elongate direction.

Preferably the second ends of the brace members are secured or adapted to be secured with the or a wheel attachment and support mechanism or the track or a secondary slide that is slidably mounted to the track and/or elongate body to move relative the elongate body in the elongate direction.

Preferably the wheel attachment and support mechanism is attached to the secondary slide.

Preferably the wheel attachment and support mechanism is pivotally attached to the secondary slide.

Preferably the wheel attachment and support mechanism translates with the secondary slide as it moves relative the elongate body.

Preferably the secondary slides moves between a first and second position relative the elongate body, the first position corresponding to the first position of the slide and the second position corresponding to a position of the slide intermediate of its first and second positions.

Preferably first and second positions of the secondary slide are defined by stops.

Preferably, the slide (collar) first moves from the first position to the second position and the secondary slide then moves from its first position to second position, keeping the struts proximal to the elongate body, and when the secondary slide reaches its second position the movement of the secondary slide stops while the slide continues to move to its second position whereupon the struts start to move to their deployed condition as the slide is moved towards the secondary slide.

Preferably, the slide (collar) first moves from the first position to the second position and the secondary slide then moves from its first position to second position, keeping the separation of the slide and secondary slide the same.

Preferably, in the first position of the slide, the slide is more proximal to the first end of the elongate body than in its second position.

Preferably, in the first position of the secondary slide, the secondary slide is more proximal to the first end of the elongate body that in its second position.

Preferably, the secondary slide moves from its first position to its second position, by moving the slide from its first position to the second position.

Preferably, the track comprises two parallel spaced apart rails and the secondary slide is connected to and spans between the two rails.

Preferably, the track comprises two parallel spaced apart rails and the secondary slide is a U-shaped member telescopically connected to the two rails as ends of the rails proximal the second end of the elongate body.

Preferably, the proximal end of each strut is able to translate relative the elongate body and to the second end of the brace member that it is secured to, the second end of the brace member also able to translate relative the elongate body.

Preferably, the brace members are rods or tubes.

Preferably, the first end of each of the brace member is secured or adapted to be secured to the struts via fixed or removable securing arrangement and the mounting of the second ends of the brace members are via pivotal, hinged or slidable arrangement.

Preferably, the storage compartment terminates at a distance on the first end side of the second end of the elongate body.

Preferably, the golf club carrier comprises a storage compartment lid for closing the storage compartment to conceal and enclose the trundler mechanism inside the storage compartment when in its stowed condition and which when open reveals the trundler mechanism.

Preferably, the storage compartment lid is pivotally mounted relative to (and preferably to) the elongate body.

Preferably, the storage compartment lid comprises a pocket suitable for storing of one or more items.

Preferably, the storage compartment lid comprises a cavity or recess for holding a bottle.

Preferably, the storage compartment lid comprises a gripping portion that is adapted to facilitate gripping by at least one hand of a user.

Preferably, the storage compartment lid doubles as a handle for pushing, pulling and controlling the direction of the golf club carrier when transported in a rolling manner over the ground.

Preferably, there is provided a handle for pushing, pulling and controlling the direction of the golf club carrier when transported in a rolling manner over the ground.

Preferably, the handle doubles as the storage compartment lid as herein described.

Preferably, the handle can move between a condition parallel the elongate body and a condition for use presented in a position rotated more than 90 degrees from its condition parallel.

Preferably, the compartment lid can move between a condition parallel the elongate body when in the closed position and a condition for use presented as a handle in a position rotated more than 90 degrees from its closed position.

Preferably, the angle of the storage compartment lid can be adjusted and set relative to the elongate direction.

Preferably, the angle of the handle or lid is able to have its angle of set adjusted.

Preferably, the gripping portion includes a button that when depressed allows the angle storage compartment lid, or both to be adjusted upwards or downwards.

Preferably, release of the button causes the angle to be set or locked.

Preferably, at least one handle is mounted/secured or formed on the exterior of the elongate body as a body handle.

Preferably the struts are pivotally mounted relative the elongate body.

Preferably the struts are pivotally mounted relative the or each respective collar.

Preferably, the trundler mechanism comprises at least two brace members, each brace member extending between a first end and a second end, the first end of each brace member is mounted/secured or adapted to be mounted/secured to one of the struts (preferably with each strut mounted/secured or adapted to be mounted/secured with one brace member only), and wherein the second ends of the brace members are mounted/secured or adapted to be mounted/secured with the elongate body, or the wheel attachment and support mechanism, or the rails.

Preferably, the first end of each of the brace member is mounted/secured or adapted to be mounted/secured to the struts (preferably at or near the distal end of each strut) via fixed or removable arrangement and the mounting of the second ends of the brace members are via pivotal, hinged or slidable arrangement.

Preferably the collar is at or nearer the first end of the elongate body when the struts are in their stowed condition and are more proximal the second end of the elongate body when the struts are in their deployed condition.

Preferably, the golf club carrier comprises a storage compartment lid (preferably pivotally mounted to the elongate body) which when closed conceals/encloses the storage compartment and which when open reveals the storage compartment.

Preferably, the storage compartment does not extend to the second end of the elongate body.

Preferably, the distance between the second end of the elongate body and the storage compartment is greater than 50 mm.

Preferably, the distance between the second end of the elongate body and the storage compartment is greater than 100 mm.

Preferably, the length and the shape of the elongate body remains unaffected/unchanged by the presence of the trundler mechanism.

Preferably, the storage compartment lid comprises a pocket (preferably made out of plastic material or mesh) suitable for storage of items such as but not limited to golf balls, mobile phones, wallets and score cards.

Preferably, the storage compartment lid comprises a cavity to hold a water or drinks bottle.

Preferably, the storage compartment lid comprises a gripping portion (or handle) that is adapted to facilitate gripping by hand(s) of a user.

Preferably, the storage compartment lid comprises a flat surface portion.

Preferably, at least one handle is mounted/secured or formed (preferably integrally formed) on the exterior of the elongate body.

Preferably, at least one handle is located at the storage compartment, the at least one handle being able to be moved from the stored condition adjacent/in/parallel the storage compartment and deployed condition extending away and preferably upwards (when the trundler is in use) from the elongate body.

Preferably, the gripping portion (or handle) contains a button which when depressed allows the angle of the handle, storage compartment lid, or both to be adjusted upwards or downwards.

Preferably, the wheel compartment lid and/or the storage compartment lid is/are pivotable about an axis that is orthogonal to longitudinal axis of the elongate body.

Preferably, in the deployed condition, the struts are angled less than 90 degrees (preferably between 30 degrees and 75 degrees) from the elongate body.

Preferably, in the deployed condition the brace members are mounted/secured or adapted to be mounted/secured to the struts in such a way that the angle between the elongate body and each of the brace members are less than 90 degrees.

Preferably, in the deployed condition the elongate body is tilted at an angle (preferably at least 40 degrees) from horizontal.

Preferably, in use, the elongate body is supported above the ground by three wheels.

Preferably in use, the line of roll of the two wheels supported by the two struts are on each side of the line of roll of the third or front wheel.

Preferably in use, the line of roll of the third or front wheel lies in a plane that also passes through the elongate direction axis of the elongate body.

Preferably the three wheels contact the ground at three points each at an apex of a notional triangle.

Preferably the third or front wheel is mounted/secured, in use, as an idler wheel.

Preferably when deployed the axis of rotation of the strut mounted/secured wheels are coaxial.

Preferably, the three wheels support the elongate body above a horizontal or substantially horizontal surface at an incline of between 40 and 90 degrees (more preferably 45 degrees) to the horizontal or the substantially horizontal surface.

Preferably, in use, the wheels that are received and secured at the distal ends of the struts are away from the elongate body more and side of centreline travel direction and the wheel received and secured at the distal end of the wheel attachment and support mechanism is close to elongate body and preferably on centreline of travel.

Preferably, the elongate body comprises a wheel compartment configured to store at least two wheels and preferably three wheels inside the wheel compartment, the wheel compartment being located (preferably integrally formed) at a bottom region of the elongate body that is proximal to the second end.

Preferably, the elongate body comprises a wheel compartment lid (preferably pivotally mounted to the elongate body) which when closed fully conceals/encloses the wheel compartment at the bottom region and which when open reveals the storage compartment thereby providing access to the storage compartment from the bottom region.

Preferably, the elongate body comprises a separator for separating the at least one golf club receiving compartment from the wheel compartment.

Preferably, the separator is formed by at least one golf club storage compartment.

Preferably, each of the wheels have one or more through openings and the separator is of the shape that complements the shape of at least some of the openings of each wheel to allow the separator to project into the one or more through openings of the wheels when the wheels are stored in the wheel compartment, and to accommodate at least one golf club in such a manner that a club handle of the at least one golf club can locate in one of the through openings of the at least one wheel without coming into contact with the wheels.

Preferably, when stored in the wheel compartments the wheels are biased for movement in a direction towards the base (by way of gravity and/or biasing means).

Preferably, the separator is configured to allow the club handle of the golf club to locate at the openings of each wheel without said at least one golf club coming into contact with said wheels.

Preferably, at least two of the wheels nest (at least partially nest) inside each other when stored inside the wheel compartment.

Preferably, the length of each strut is no longer than 550 mm.

Preferably, the length of each strut is 471 mm (or about 471 mm).

Preferably, the length of each brace member is no longer than 400 mm.

Preferably, the length of each brace member is 315 mm (or about 315 mm).

Preferably, the length of the elongate body from the first end to second end is no longer than 1000 mm.

Preferably, the length of the elongate body from the first end to second end is 902 mm (or about 902 mm).

Preferably, the length of the wheel compartment is 230 mm from the second compartment.

Preferably, the elongate body is circular or substantially circular in cross-section in an axis that is orthogonal to the length of the elongate body.

Preferably, the elongate body is polygonal in cross-section in an axis that is orthogonal to the length of the elongate body.

Preferably, the elongate body is made from plastic, polyvinyl chloride (PVC), polyethylene or a combination thereof.

Preferably, the two rails are attached or integrally formed with a secondary slide (preferably, U-shaped member) at or near the bottom.

Preferably, the end of the wheel attachment and support mechanism that is proximal to the elongate body is pivotally mounted to the secondary slide or U-shaped member.

Preferably, the secondary slide or U-shaped member is part of the wheel attachment and support mechanism.

Preferably, each brace member extends between the U-shaped member (secondary slide) and the respective struts.

Preferably, the brace members are elongate members such as rods or tubes.

Preferably, the brace members in the stored condition are parallel each other and preferably parallel to the elongate direction of the elongate body.

Preferably, the brace members at their proximal end are attached to the elongate body and at their distal end are attached to the respective strut.

Preferably, the brace members are pivotally mounted to a respective strut.

Preferably, the brace members are mounted/secured to a respective strut intermediate of the ends of the strut.

Preferably, the brace members are not translationally mounted/secured to said elongate body.

Preferably, the brace members are translationally mounted/secured to said elongate body.

Preferably, the brace members are not translationally mounted/secured to a respective said strut.

Preferably, the brace members are translationally mounted/secured to a respective said strut.

According to a third aspect, the invention resides in a trundler mechanism that is configured to be mounted/secured to a body of a golf club carrier, the trundler mechanism comprising two struts adapted to be mounted/secured to the body of a golf club carrier, wherein during use and when mounted/secured to the body, the trundler mechanism is configured to be moved from its collapsed condition with the struts folded towards the body to a deployed condition where the at least two struts are presented in a manner extending from their proximal ends away from the body and the distal end of each of the struts is able to receive and secure one wheel to allow the carrier to be transported over ground during use.

Preferably, the trundler mechanism is configured to pivotally move from its collapsed condition to the deployed condition.

Preferably, the struts are of telescopic arrangement and are adjustable in length.

Alternatively, preferably the struts are not adjustable in length.

Preferably, the struts are elongate.

Preferably the struts extend in the elongate direction of the body when in the stowed condition and extend at an acute angle to the elongate direction of the body when in the deployed condition.

Preferably, the struts are rods or tubes.

Preferably, the trundler mechanism further comprises a wheel attachment and support mechanism having a proximal end and a distal end, wherein the wheel attachment and support mechanism is configured to be pivoted between a collapsed condition substantially towards the body to a deployed condition where the wheel attachment and support mechanism is presented in a manner extending away from the body with the proximal end of the wheel attachment and support mechanism being presented in a manner extending from its proximal end away from the body and the distal end of the wheel attachment and support mechanism is able to receive and secure one wheel to allow the carrier to be transported over ground.

Preferably, the third or wheel attachment and support mechanism is a fork.

Preferably, the wheel attachment and support mechanism is a front wheel attachment and support mechanism.

Preferably, the fork is a telescopic fork that is adjustable in length.

Preferably, the trundler mechanism comprises two spaced apart rails and at least one collar mounted/secured to the rails and is configured to slide along the rails, wherein the proximal end of each strut is mounted/secured to the at least one collar.

Preferably, the proximal end of each strut is pivotally mounted to the at least one collar.

Preferably, the proximal end of each strut is pivotally mounted to the at least one collar.

Preferably the body is an elongate body extending between a first end and a second end in an elongate direction and the collar can slide along its respective rail in a direction parallel to the elongate direction of the body.

Preferably the proximal end of each strut is configured to slide with the collar in a direction parallel the elongate direction of the body.

Preferably the collar is configured to lock to the or each respective rail with a locking mechanism.

Preferably the struts are pivotally mounted relative the body.

Preferably the struts are pivotally mounted relative the at least one collar.

Preferably, the trundler mechanism comprises at least two brace members, each brace member extending between a first end and a second end, the first end of each brace member is mounted/secured or adapted to be mounted/secured to one of the struts with each strut mounted/secured or adapted to be mounted/secured with one brace member only, and wherein the second ends of the brace members are mounted/secured or adapted to be mounted/secured with the body, or the wheel attachment and support mechanism, or the rails.

Preferably, the first end of each of the brace member is mounted/secured or adapted to be mounted/secured to the struts (preferably but not necessarily at or near the distal end of each strut) via fixed or removable arrangement and the mounting of the second ends of the brace members are via pivotal, hinged or slidable arrangement.

Preferably the brace members are elongate members such as rods or tubes.

Preferably the brace members in the stored condition are parallel each other and preferably parallel to an elongate direction of the body.

Preferably the brace members at their proximal end are attached to the body and at their distal end are attached to the respective strut.

Preferably the brace members are pivotally mounted to a respective strut.

Preferably the brace members are mounted/secured to a respective strut intermediate of the ends of the strut.

Preferably the brace members are not translationally mounted/secured to said body.

Preferably the brace members are translationally mounted/secured to said body.

Preferably the brace members are not translationally mounted/secured to a respective said strut.

Preferably the brace members are translationally mounted/secured to a respective said strut.

Preferably, the collar is at or proximal to first end of the body when in the collapsed condition and are more proximal the second end of the body when in the deployed condition.

Preferably, the trundler mechanism comprises at least one handle, wherein the at least one handle being able to be moved from the collapsed condition adjacent/in/parallel the body and deployed condition extending away and preferably upwards from the body.

Preferably, when in the deployed condition, the struts are angled less than 90 degrees from the body.

Preferably, in the deployed condition, the struts are angled between 30 degrees and 75 degrees from the body.

Preferably, when in use and in the deployed condition the brace members are mounted/secured or adapted to be mounted/secured to the struts so that the angle between the body and each of the brace members are less than 90 degrees.

Preferably, the two rails are attached or integrally formed with a secondary slide or U-shaped member at or near the bottom.

Preferably, end of the wheel attachment and support mechanism that is proximal to the body is pivotally mounted to the secondary slide or U-shaped member.

Preferably, the secondary slide or U-shaped member is part of the wheel attachment and support mechanism.

Preferably, each brace member extend between the U shaped member and the respective struts.

Preferably, the carrier is the one as described is any one of the above aspects.

Preferably, the trundler mechanism is configured to move pivotally from the stowed condition to the deployed condition.

Preferably, the trundler mechanism is configured to be permanently attached to the elongate body.

Preferably, the trundler mechanism further comprises at least two spaced apart and parallel rails and the at least one collar is adapted to slide along the rails in a direction parallel to the elongate direction of the elongate body.

Preferably, the at least one collar is configured to lock to the rails with a locking mechanism.

Preferably, the struts are adjustable in length.

Preferably, the carrier is configured to be supported above the ground by at least two wheels.

Preferably, the trundler mechanism further comprises a wheel attachment and support mechanism having a proximal end and a distal end, the wheel attachment and support mechanism being configured to be pivoted between (a) a stowed condition where the wheel attachment and support mechanism is folded towards the elongate body and (b) a deployed condition where the wheel attachment and support mechanism is presented in a manner extending from the elongate body with its distal end at a position that is more distal the elongate body than in the stowed condition, and in a manner to be able to receive and secure one wheel to allow the carrier to be transported in a rolling manner over ground.

Preferably, wherein: in the stowed condition, the wheel attachment and support mechanism is folded towards the elongate body and located in the storage compartment, and in a deployed condition, the wheel attachment and support mechanism is presented in a manner extending away from the elongate body with its proximal end at the storage compartment and its distal end at a position that is more distal the storage compartment and elongate body than in the stowed condition.

Preferably, the wheel attachment and support mechanism is a fork comprising two spaced apart and parallel arms and the at least one wheel is able to be received and secured between the two arms of the fork.

Preferably, wherein the trundler mechanism comprises at least two brace members, each brace member being mounted/secured or adapted to be mounted/secured to one of the struts with each strut mounted/secured or adapted to be mounted/secured with one brace member only.

Preferably, the brace member comprises a first end and a second end, the first end of each brace member is mounted/secured or adapted to be mounted/secured to one of the struts with each strut mounted/secured or adapted to be mounted/secured with one brace member only, and wherein the second ends of the brace members are mounted/secured or adapted to be mounted/secured with the or a wheel attachment and support mechanism or the rails or a secondary slide or U-shaped member connecting the rails.

Preferably, the brace members are rods or tubes.

Preferably, the first end of each of the brace member is mounted/secured or adapted to be mounted/secured to the struts via fixed or removable arrangement and the mounting of the second ends of the brace members are via pivotal, hinged or slidable arrangement.

Preferably, the trundler mechanism is the one as described in any one of the above aspects.

According to a fourth aspect, the invention resides in a trundler mechanism of a golf club carrier that is configured to be mounted/secured to a golf club carrier having an elongate body extending at an elongate direction from a first end to a second end of the elongate body, the elongate body comprising at least one golf club receiving compartment adapted to receive golf clubs from the first end, the trundler mechanism comprising:
i. a track extending in the elongate direction (preferably parallel to the elongate direction);
ii. at least one slide (preferably a slidable collar) slidably mounted to the track and adapted to slide along the track in the elongate direction (preferably parallel to the elongate direction) of the elongate body between a first position and a second position; and
iii. at least two struts each having a proximal end and a distal end, the proximal ends of each strut being mounted to the slide and/or the track in a manner to be able to pivot relative to the track; and

wherein trundler mechanism is reconfigurable between (a) a stowed condition where each strut is positioned with its distal end proximal the elongate body when the slide is in the first position and (b) a deployed condition when the slide is in the second position where each strut is presented with its distal end more distal from the elongate body than when in the stowed condition in a manner extending from the proximal end away from the elongate body, each strut able to receive and secure a wheel at or near the distal end of each strut to allow the carrier to be transported in a rolling manner over ground.

Preferably, the trundler mechanism is the one as described in any one of the above aspects.

According to a fifth aspect, the invention resides in a golf club carrier comprising:

an elongate body extending in an elongate direction and having a first end and a second end, the elongate body comprising at least one golf club receiving compartment adapted to receive golf clubs from the first end,

a trundler mechanism attached or for attaching to the elongate body,

the trundler mechanism comprising:
i. a track extending in the elongate direction;
ii. at least one slide (preferably a slidable collar) slidably mounted to the track and adapted to slide along the track in the elongate direction (preferably parallel to the elongate direction) of the elongate body between a first position and a second position; and
iii. at least two struts each having a proximal end and a distal end, the proximal ends of each strut being mounted to the slide and/or the track in the manner to be able to pivot relative to the track; and

at least two wheels, wherein the elongate body comprises a wheel compartment located at the second end of the elongate body and configured to store said at least two wheels, the at least two wheels being able to releasably couple together (preferable in a partially nested manner) in a co-axial manner for storage inside the wheel compartment,

wherein trundler mechanism is reconfigurable between (a) a stowed condition where each strut is positioned with its distal end proximal the elongate body when the slide is in the first position and (b) a deployed condition when the slide is in the second position where each strut is presented with its distal end more distal from the elongate body than when in the stowed condition in a manner extending from the proximal end away from the elongate body, each strut able to receive and secure one wheel of the at least two wheels at or near the distal end of each strut to allow the carrier to be transported in a rolling manner over ground.

Preferably, the track extends parallel to the elongate direction.

Preferably, the golf club carrier further comprises a storage compartment that is configured to stow the trundler mechanism, the storage compartment being presented adjacent the elongate body, wherein:
in the stowed condition of the trundler mechanism, the struts are positioned to locate in the storage compartment, and
in the deployed condition of the trundler mechanism each of the struts are presented extending, out of the storage compartment (preferably from the slide in the storage compartment), in a manner extending away from the elongate body.

Preferably, each wheel has a rim and one of the at least two wheels comprises protrusions formed on at least one side of its rim, the protrusions of said at least one wheel being configured to be received by complementary features formed on the rim of the other of said two wheels for releasable coupling of the at least two wheels.

Preferably, each of the at least two wheels comprises spokes and the spokes of the at least two wheels are aligned when the at least two wheels are releasably coupled together.

Preferably, the complementary features are notches or grooves that are sized and shaped to receive the protrusions.

Preferably, the wheel compartment is configured to store at least three wheels in a co-axial manner.

Preferably, the struts are parallel to each other in the stowed condition.

Preferably, at least two of the three wheels at least partially nest with the third wheel when stored inside the wheel compartment.

Preferably, the struts are configured to move pivotally relative the slide and/or track when the trundler mechanism reconfigures between the stowed condition to the deployed condition.

Preferably, the elongate body is of a unitary construction.

Preferably, the struts are parallel to each other in the stowed condition.

Preferably, the struts are splay away from each other in the deployed condition from their proximal ends.

Preferably, the storage compartment is presented adjacent the elongate body on an external surface of the elongate body.

Preferably, the storage compartment is integrally formed with the elongate body.

Preferably, the trundler mechanism is permanently attached to the elongate body.

Preferably, the track comprises two spaced apart and parallel rails and the at least one slide is adapted to slide along the rails between its first and second positions in the elongate direction of the elongate body.

Preferably, the track comprises two spaced apart and parallel rails and the at least one slide is adapted to slide along the rails between its first and second positions in a direction parallel to the elongate direction of the elongate body.

Preferably, the at least one slide is configured to releasably lock to the track by a locking mechanism.

Preferably, the struts are adjustable in length.

Preferably, the carrier is configured to be supported above the ground by at least two wheels.

Preferably, wherein the trundler mechanism further comprises a wheel attachment and support mechanism dependent from the elongate body and having a proximal end and a distal end.

Preferably, the wheel attachment and support mechanism is configured to be move (preferably pivoted) between (a) a stowed condition where the wheel attachment and support mechanism is located more proximal the elongate body and (b) a deployed condition where the wheel attachment and support mechanism is presented in a manner extending from the elongate body with its distal end at a position that is more distal the elongate body than in the stowed condition, and in a manner to be able to receive and secure a wheel that, in cooperation with the first and second mentioned wheels, allow the carrier to be rolled over ground.

Preferably, wherein: (a) in the stowed condition of the wheel attachment and support mechanism, the wheel attachment and support mechanism is positioned proximal the elongate body and preferably substantially or entirely located in the storage compartment, and
(b) in a deployed condition of the wheel attachment and support mechanism, the wheel attachment and support mechanism is presented in a manner extending away from the elongate body with its proximal end at or more proximal or adjacent the storage compartment and its distal end at a position that is more distal the storage compartment and elongate body than when in the stowed condition.

Preferably, the wheel attachment and support mechanism comprises a fork comprising two spaced apart and parallel arms and the at least one wheel is able to be received and secured between the two arms of the fork.

Preferably, the wheel attachment and support mechanism is a front wheel attachment and support mechanism.

Preferably, the golf club carrier is configured to be supported above the ground by three wheels.

Preferably, the three wheels comprises two rear wheels configured to be received and secured by the struts and a front wheel configured to be received and secured by the wheel attachment and support mechanism.

Preferably, elongate body comprises a wheel compartment configured to store at least two wheels that are configured to support the carrier on the ground, the wheel compartment being located at the second end of the elongate body.

Preferably, the at least one golf club compartment extends to the wheel compartment, and preferably into and/or through the wheel compartment.

Preferably, the at least two wheels at least partially nest with each other when stored inside the wheel compartment.

Preferably, the struts move pivotally with respect to the slide between the stowed and deployed condition.

Preferably, the at least two wheels are able to releasably couple together (preferable in a partially nested manner) in a co-axial manner for storage inside the wheel compartment.

Preferably, at least one of the at least two wheels comprises at least one protrusion formed on at least one side of its rim, the at least one protrusion of said at least one wheel being configured to be received by at least one complementary feature formed on the rim of the other for the releasable coupling of the at least two wheels.

Preferably, at least one of the at least two wheels comprises a plurality of protrusions formed on at least one side of its rim, the protrusions of said at least one wheel being configured to be received by a plurality of complementary feature formed on the rim of the other for the releasable coupling of the at least two wheels.

Preferably, the complementary features are notches or grooves that are sized and shaped to receive the protrusions.

Preferably, each of the at least two wheels comprises spokes and the spokes of the at least two wheels are aligned when the at least two wheels are coupled together.

Preferably, the wheel compartment is configured to store three wheels in a coaxial manner.

Preferably, the at least two of the three wheels at least partially nest with the third wheel when stored inside the wheel compartment.

Preferably, the golf club carrier further comprises a brake system to slow or stop the golf club carrier rolling over ground.

Preferably, the brake system comprises a pin able to engage with part of at least one of said wheels to prevent the wheel from continuously rotating.

Preferably at least one of the wheels comprises a plurality of holes preferably on its rim, wherein in use the pin is adapted to be received by one of the plurality of holes thereby causing to slow or stop the golf club carrier rolling over ground.

Preferably, the brake system is a cable brake system comprising a brake handle that is operatively connected to a brake pad by a cable so that when the brake handle is a first position a tension is caused in the cable that allows the brake pad to engage with at least one of the wheels, or with an external tread of said at least one of the wheels thereby to slow or stop the golf club carrier rolling over ground.

Preferably, said at least one of the wheels is a front wheel.

Preferably, at least one of the wheels is the at least one wheel that is configured to be received or secured by the wheel attachment and support mechanism.

Preferably, wherein when the brake handle is in a first position the brake handle is more visible than when it is a second position that corresponds to the brake pad being released from the at least one of the wheels, or with an external tread of said at least one of the wheels thereby not to slow or stop the golf club carrier rolling over ground.

Preferably, wherein the brake handle is shaped (presented as) as a flag that is of a colour that is visible from a distance when in its first position.

Preferably, the trundler mechanism further comprises at least one and preferably two brace members, the or each brace member having a first and second end, the first end of the or each brace member is pivotally secured with each or a respective said strut and the second end of the or each brace member is pivotally secured relative the elongate body.

Preferably, the second end of the or each brace member is pivotally secured to the elongate body.

Preferably, the second end of the or each brace member is pivotally secured to the elongate body at or proximate the second end of the elongate body.

Preferably the first end of the or each brace member is pivotally secured to a respective strut intermediate of the proximal and distal end of each strut.

Preferably the first end of the or each brace member is pivotally secured to a respective strut proximal the mid-point of each strut.

Preferably the first end of the or each brace member is pivotally secured more proximate the proximal end of a respective strut.

Preferably the first end of the or each brace member remains at a fixed distance to the proximal end the strut it is secured to.

Preferably the first end of the or each brace member remains at a fixed distance to the distal end the strut it is secured to.

Preferably the proximal end of the or each strut is able to translate relative the second end of the brace member that it is secured to.

Preferably the proximal end of the or each strut is able to translate relative the elongate body and to the second end of the brace member that it is secured to.

Preferably, each strut is coupled to the elongate body by a brace member that extends between the elongate body and the strut, intermediate of the proximal and distal ends of the strut, so that each strut and brace member can move relative the elongate body as a slider crank mechanism.

Preferably, the trundler mechanism comprises at least two brace members, each brace member being secured or adapted to be secured to one of the struts with each strut secured or adapted to be secured with one brace member only.

Preferably, the brace member comprises a first end and a second end, the first end of each brace member is secured or adapted to be secured to one of the struts with each strut secured or adapted to be secured with one brace member only, and wherein the second ends of the brace members are secured or adapted to be secured with the or a wheel attachment and support mechanism or the track or secondary slide that is slidably mounted to the track and/or elongate body to move relative the elongate body in the elongate direction.

Preferably the second ends of the brace members are secured or adapted to be secured with the or a wheel attachment and support mechanism or the track or a secondary slide that is slidably mounted to the track and/or elongate body to move relative the elongate body in the elongate direction.

Preferably the wheel attachment and support mechanism is attached to the secondary slide.

Preferably the wheel attachment and support mechanism is pivotally attached to the secondary slide.

Preferably the wheel attachment and support mechanism translates with the secondary slide as it moves relative the elongate body.

Preferably the secondary slides moves between a first and second position relative the elongate body, the first position corresponding to the first position of the slide and the second position corresponding to a position of the slide intermediate of its first and second positions.

Preferably first and second positions of the secondary slide are defined by stops.

Preferably, the slide (collar) first moves from the first position to the second position and the secondary slide then moves from its first position to second position, keeping the struts proximal to the elongate body, and when the secondary slide reaches its second position the movement of the secondary slide stops while the slide continues to move to its second position whereupon the struts start to move to their deployed condition as the slide is moved towards the secondary slide.

Preferably, the slide (collar) first moves from the first position to the second position and the secondary slide then moves from its first position to second position, keeping the separation of the slide and secondary slide the same.

Preferably, in the first position of the slide, the slide is more proximal to the first end of the elongate body that in its second position.

Preferably, in the first position of the secondary slide, the secondary slide is more proximal to the first end of the elongate body that in its second position.

Preferably, the secondary slide moves from its first position to its second position, by moving the slide from its first position to the second position.

Preferably, the track comprises two parallel spaced apart rails and the secondary slide is connected to and spans the two rails.

Preferably, the track comprises two parallel spaced apart rails and the secondary slide is a U-shaped member telescopically connected to the two rails as ends of the rails proximal the second end of the elongate body.

Preferably, the proximal end of each strut is able to translate relative the elongate body and to the second end of the brace member that it is secured to, the second end of the brace member also able to translate relative the elongate body.

Preferably, the brace members are rods or tubes.

Preferably, the first end of each of the brace member is secured or adapted to be secured to the struts via fixed or removable securing arrangement and the mounting of the second ends of the brace members are via pivotal, hinged or slidable arrangement.

Preferably, the storage compartment terminates at a distance on the first end side of the second end of the elongate body.

Preferably, the golf club carrier comprises a storage compartment lid for closing the storage compartment to conceal and enclose the trundler mechanism inside the storage compartment when in its stowed condition and which when open reveals the trundler mechanism.

Preferably, the storage compartment lid is pivotally mounted relative to (and preferably to) the elongate body.

Preferably, the storage compartment lid comprises a pocket suitable for storing of one or more items.

Preferably, the storage compartment lid comprises a cavity or recess for holding a bottle.

Preferably, the storage compartment lid comprises a gripping portion that is adapted to facilitate gripping by at least one hand of a user.

Preferably, the storage compartment lid doubles as a handle for pushing, pulling and controlling the direction of the golf club carrier when transported in a rolling manner over the ground.

Preferably, there is provided a handle for pushing, pulling and controlling the direction of the golf club carrier when transported in a rolling manner over the ground.

Preferably, the handle doubles as the storage compartment lid as herein described.

Preferably, the handle can move between a condition parallel the elongate body and a condition for use presented in a position rotated more than 90 degrees from its condition parallel.

Preferably, the compartment lid can move between a condition parallel the elongate body when in the closed position and a condition for use presented as a handle in a position rotated more than 90 degrees from its closed position.

Preferably, the angle of the storage compartment lid can be adjusted and set relative to the elongate direction.

Preferably, the angle of the handle or lid is able to have its angle of set adjusted.

Preferably, the gripping portion includes a button that when depressed allows the angle storage compartment lid, or both to be adjusted upwards or downwards.

Preferably, release of the button causes the angle to be set or locked.

Preferably, at least one handle is mounted/secured or formed on the exterior of the elongate body as a body handle.

Preferably the struts are pivotally mounted relative the elongate body.

Preferably the struts are pivotally mounted relative the or each respective collar.

Preferably, the trundler mechanism comprises at least two brace members, each brace member extending between a first end and a second end, the first end of each brace member is mounted/secured or adapted to be mounted/secured to one of the struts (preferably with each strut mounted/secured or adapted to be mounted/secured with one brace member only), and wherein the second ends of the brace members are mounted/secured or adapted to be mounted/secured with the elongate body, or the wheel attachment and support mechanism, or the rails.

Preferably, the first end of each of the brace member is mounted/secured or adapted to be mounted/secured to the struts (preferably at or near the distal end of each strut) via fixed or removable arrangement and the mounting of the second ends of the brace members are via pivotal, hinged or slidable arrangement.

Preferably the collar is at or nearer the first end of the elongate body when the struts are in their stowed condition and are more proximal the second end of the elongate body when the struts are in their deployed condition.

Preferably, the golf club carrier comprises a storage compartment lid (preferably pivotally mounted to the elongate body) which when closed conceals/encloses the storage compartment and which when open reveals the storage compartment.

Preferably, the storage compartment does not extend to the second end of the elongate body.

Preferably, the distance between the second end of the elongate body and the storage compartment is greater than 50 mm.

Preferably, the distance between the second end of the elongate body and the storage compartment is greater than 100 mm.

Preferably, the length and the shape of the elongate body remains unaffected/unchanged by the presence of the trundler mechanism.

Preferably, the storage compartment lid comprises a pocket (preferably made out of plastic material or mesh) suitable for storage of items such as but not limited to golf balls, mobile phones, wallets and score cards.

Preferably, the storage compartment lid comprises a cavity to hold a water or drinks bottle.

Preferably, the storage compartment lid comprises a gripping portion (or handle) that is adapted to facilitate gripping by hand(s) of a user.

Preferably, the storage compartment lid comprises a flat surface portion.

Preferably, at least one handle is mounted/secured or formed (preferably integrally formed) on the exterior of the elongate body.

Preferably, at least one handle is located at the storage compartment, the at least one handle being able to be moved from the stored condition adjacent/in/parallel the storage compartment and deployed condition extending away and preferably upwards (when the trundler is in use) from the elongate body.

Preferably, the gripping portion (or handle) contains a button which when depressed allows the angle of the handle, storage compartment lid, or both to be adjusted upwards or downwards.

Preferably, the wheel compartment lid and/or the storage compartment lid is/are pivotable about an axis that is orthogonal to longitudinal axis of the elongate body.

Preferably, in the deployed condition, the struts are angled less than 90 degrees (preferably between 30 degrees and 75 degrees) from the elongate body.

Preferably, in the deployed condition the brace members are mounted/secured or adapted to be mounted/secured to the struts in such a way that the angle between the elongate body and each of the brace members are less than 90 degrees.

Preferably, in the deployed condition the elongate body is tilted at an angle (preferably at least 40 degrees) from horizontal.

Preferably, in use, the elongate body is supported above the ground by three wheels.

Preferably in use, the line of roll of the two wheels supported by the two struts are on each side of the line of roll of the third or front wheel.

Preferably in use, the line of roll of the third or front wheel lies in a plane that also passes through the elongate direction axis of the elongate body.

Preferably the three wheels contact the ground at three points each at an apex of a notional triangle.

Preferably the third or front wheel is mounted/secured, in use, as an idler wheel.

Preferably when deployed the axis of rotation of the strut mounted/secured wheels are coaxial.

Preferably, the three wheels support the elongate body above a horizontal or substantially horizontal surface at an incline of between 40 and 90 degrees (more preferably 45 degrees) to the horizontal or the substantially horizontal surface.

Preferably, in use, the wheels that are received and secured at the distal ends of the struts are away from the elongate body more and side of centreline travel direction and the wheel received and secured at the distal end of the wheel attachment and support mechanism is close to elongate body and preferably on centreline of travel.

Preferably, the elongate body comprises a wheel compartment configured to store at least two wheels and preferably three wheels inside the wheel compartment, the wheel compartment being located (preferably integrally formed) at a bottom region of the elongate body that is proximal to the second end.

Preferably, the elongate body comprises a wheel compartment lid (preferably pivotally mounted to the elongate body) which when closed fully conceals/encloses the wheel compartment at the bottom region and which when open reveals the storage compartment thereby providing access to the storage compartment from the bottom region.

Preferably, the elongate body comprises a separator for separating the at least one golf club receiving compartment from the wheel compartment.

Preferably, the separator is formed by at least one golf club storage compartment.

Preferably, each of the wheels have one or more through openings and the separator is of the shape that complements the shape of at least some of the openings of each wheel to allow the separator to project into the one or more through openings of the wheels when the wheels are stored in the wheel compartment, and to accommodate at least one golf club in such a manner that a club handle of the at least one golf club can locate in one of the through openings of the at least one wheel without coming into contact with the wheels.

Preferably, when stored in the wheel compartments the wheels are biased for movement in a direction towards the base (by way of gravity and/or biasing means).

Preferably, the separator is configured to allow the club handle of the golf club to locate at the openings of each wheel without said at least one golf club coming into contact with said wheels.

Preferably, at least two of the wheels nest (at least partially nest) inside each other when stored inside the wheel compartment.

Preferably, the length of each strut is no longer than 550 mm.

Preferably, the length of each strut is 471 mm (or about 471 mm).

Preferably, the length of each brace member is no longer than 400 mm.

Preferably, the length of each brace member is 315 mm (or about 315 mm).

Preferably, the length of the elongate body from the first end to second end is no longer than 1000 mm.

Preferably, the length of the elongate body from the first end to second end is 902 mm (or about 902 mm).

Preferably, the length of the wheel compartment is 230 mm from the second compartment.

Preferably, the elongate body is circular or substantially circular in cross-section in an axis that is orthogonal to the length of the elongate body.

Preferably, the elongate body is polygonal in cross-section in an axis that is orthogonal to the length of the elongate body.

Preferably, the elongate body is made from plastic, polyvinyl chloride (PVC), polyethylene or a combination thereof.

Preferably, the two rails are attached or integrally formed with a secondary slide (preferably a U-shaped member) at or near the bottom.

Preferably, the end of the wheel attachment and support mechanism that is proximal to the elongate body is pivotally mounted to the secondary slide or U-shaped member.

Preferably, the secondary slide or U-shaped member is part of the wheel attachment and support mechanism.

Preferably, each brace member extends between the secondary slide or U-shaped member (secondary slide) and the respective struts.

Preferably, the brace members are elongate members such as rods or tubes.

Preferably, the brace members in the stored condition are parallel each other and preferably parallel to the elongate direction of the elongate body.

Preferably, the brace members at their proximal end are attached to the elongate body and at their distal end are attached to the respective strut.

Preferably, the brace members are pivotally mounted to a respective strut.

Preferably, the brace members are mounted/secured to a respective strut intermediate of the ends of the strut.

Preferably, the brace members are not translationally mounted/secured to said elongate body.

Preferably, the brace members are translationally mounted/secured to said elongate body.

Preferably, the brace members are not translationally mounted/secured to a respective said strut.

Preferably, the brace members are translationally mounted/secured to a respective said strut.

According to a sixth aspect, the invention resides in a golf club carrier comprising:

an elongate body extending in an elongate direction and having a first end and a second end, the elongate body comprising at least one golf club receiving compartment adapted to receive golf clubs from the first end,

a trundler mechanism attached or for attaching to the elongate body, the trundler mechanism comprising:
i. a track;
ii. at least one slide (preferably a slidable collar) slidably mounted to the track and adapted to slide along the track in a direction parallel to the elongate direction of the elongate body between a first position and a second position; and
iii. at least two struts each having a proximal end and a distal end, the proximal ends of each strut being pivotably mounted to the slide; and
iv. at least one brace member for each strut extending between and in a pivotal manner relative to each strut and the elongate body,
wherein trundler mechanism is reconfigurable between (a) a stowed condition where each strut and respective brace member are more parallel each other and to the elongate direction than when in a deployed condition where each strut and respective brace member are less parallel each other and to the elongate direction.

Preferably, the golf club carrier comprises the features as described in any one of the statements of the first aspect above.

According to a seventh aspect, the invention resides in a golf club carrier having a trundler mechanism incorporated, the golf club carrier comprising an elongate body extending in an elongate direction from a first end to a second end of the elongate body, the elongate body comprising at least one golf club receiving compartment adapted to receive golf clubs from the first end, the trundler mechanism comprising:
i. at least two struts each having a proximal end and a distal end, each strut being mounted with the elongate body to pivot relative to the elongate body and translate at the proximal end relative to the body; two struts
ii. for each strut, a brace that is pivotally secured at (i) a first end of the brace to the strut at a location intermediate the proximal and distal end of the strut, and (ii) a second end of the brace with the elongate body, so that each strut and brace member can move relative the elongate body as a slider crank mechanism,

wherein each strut is able to receive and secure a wheel at or near the distal end of each strut to allow the carrier to be transported in a rolling manner over ground.

Preferably the trundler mechanism is reconfigurable between (a) a stowed condition where each strut is positioned with its distal end proximal the elongate body and (b) a deployed condition where each strut is presented with its distal end more distal from the elongate body than when in the stowed condition in a manner extending away from the proximal end from the elongate body.

Preferably each strut pivots relative to the elongate body about a pivot axis at the proximal end of the strut.

Preferably the pivot axis is defined by a slide.

Preferably, the golf club carrier comprises the features as described in any one of the statements of the first aspect above.

According to an eighth aspect, the invention resides in a golf club carrier skin to envelop a golf club carrier that comprises an elongate body with a first end and an opposite second end of the body and at least one golf club receiving compartment adapted to receive golf clubs from the first end,

wherein the skin is of a flexible construction able to wrap around the body, save for at least the first end of the body.

Preferably, the skin is able to be fastened to at least one of (a) itself and (b) the body, to secure the skin to the body.

Preferably, the skin includes an interior to located snugly about the elongate body.

Preferably, the skin includes an interior to locate snugly about the elongate body yet is able to be exposed by a split extending from the top to or towards the bottom of the skin via which the elongate body can enter the skin.

Preferably, the split is able to be closed and preferably includes a closure mechanism to hold the split in a closed condition.

Preferably, the skin includes a split that allows the skin to peal open to allow for the elongate body to be inserted into the skin in a direction lateral to the elongate direction.

Preferably, the skin includes at least one pocket.

Preferably, the at least one pocket is able to be opened and closed.

Preferably, the skin includes at least one handle.

Preferably, the skin includes an opening for a handle on the elongate body to pass through.

According to a ninth aspect, the present invention resides in a method of covering a golf club carrier, that comprises an elongate body with a first end and an opposite second end of the body and at least one golf club receiving compartment adapted to receive golf clubs from the first end, with a skin that is both decorative and functional to substantially obscure the body from visibility the method comprising enveloping a skin as herein defined about the body and securing the skin to the body.

Preferably the method comprises presenting a skin with its split in an open condition and wrapping the skin laterally to the elongate direction about the body.

Preferably, the skin is able to be manipulated by a user to be in an open condition wherein the skin is presented to receive the body and a more closed condition wherein the skin is snugly wrapped around the body to engage and secure therewith.

According to a tenth aspect, the invention resides in a system for redecorating a golf club carrier that comprises an elongate body with a first end and an opposite second end of the body and at least one golf club receiving compartment adapted to receive golf clubs from the first end comprising a plurality of skins as herein before described of at least two visually distinctive character each able to be removably wrapped about the body.

Preferably the skin is made from a plurality of panels secured together by bonding or stitching.

Preferably, the body is made from a plastic, polyvinyl chloride (PVC), polyethylene material or a combination thereof.

Preferably the skin is made from a water-resistant material.

Preferably the skin is made from leather, synthetic leather, nylon, plastic, cotton, polyester, vinyl, polyurethane, elastane or a combination thereof.

Preferably, the golf club carrier comprises a storage compartment for at least two struts to each receive a wheel, the storage compartment being presented adjacent the body when wrapped around the golf club carrier, the skin being openable at the storage compartment to allow the struts to project through the skin and away from the body.

Preferably, the golf club carrier is the one as described in any one of the above aspects.

According to an eleventh aspect, the invention resides in a golf club carrier skin to envelop a golf club carrier having a body extending from a first end to a second end of the body, the body comprising at least one golf club receiving compartment adapted to receive golf clubs from the first end, wherein the skin is of a flexible construction able to wrap the body, save for at least the first end of the body.

Preferably, the body is an elongate body extending in an elongate direction from the first end to the second end.

Preferably, the skin is able to be fastened to at least one of (a) itself and (b) the body, to secure the skin to the body.

Preferably, the skin includes at least one pocket.

Preferably, the at least one pocket is able to be opened and closed.

Preferably, the skin includes at least one handle.

Preferably, the skin includes an opening for a handle on the body to pass through.

Preferably, the skin is able to be manipulated by a user to be in an open condition wherein the skin is presented to receive the body and a more closed condition wherein the skin is wrapped around the body to engage and secure therewith.

Preferably, the skin is made from a plurality of panels secured together by bonding or stitching.

Preferably, the body is made from a plastic, polyvinyl chloride (PVC), polyethylene material or a combination thereof.

Preferably, the skin is made from a water-resistant material.

Preferably, the skin is made from leather, synthetic leather, nylon, plastic, cotton, polyester, vinyl, polyurethane, elastane or a combination thereof.

Preferably, the golf club carrier comprises a storage compartment for at least two struts to each receive a wheel, the storage compartment being presented adjacent the at one golf club receiving compartment when wrapped around the golf club carrier, the skin being openable at the storage compartment to allow the struts to project through the skin and away from the body.

Preferably, the golf club carrier is the one as described in any one of the above aspects.

According to a twelfth aspect, the invention resides in a golf club carrier comprising an elongate body that is rigid and including at least one golf club receiving compartment to receive golf clubs from a first end of the elongate body and a skin of a flexible construction able to wrap the main elongate rigid body, save for at least the first end of the body.

Preferably, the skin is able to be fastened to at least one of (a) itself and (b) the body, to secure the skin to the body.

Preferably, the skin includes at least one pocket.

Preferably, the skin includes at least one handle.

Preferably, the skin includes an opening for a handle on the elongate body to pass though.

Preferably, the at least one pocket is able to be opened and closed.

Preferably, the skin is able to be manipulated by a person to be on open condition wherein the skin is presented to receive the elongate main body and a more closed condition wherein the skin is wrapped around the elongate main body to engage and secure therewith.

Preferably, the skin is made from a plurality of panels secured together by bonding or stitching.

Preferably, the body is made from a plastics, polyvinyl chloride (PVC) or polyethylene material.

Preferably, the skin is made from a water resistant material.

Preferably, the skin is made from leather, synthetic leather, nylon, plastic, cotton, polyester, vinyl, polyurethane, elastane or a combination thereof.

Preferably, the body includes a housing for at least two struts to each receive a wheel, the skin being open or openable when wrapped around the main body at the housing to allow the struts to project through the skin and away from the main body.

According to a thirteenth aspect, the invention resides in a skin for enveloping an elongate body that is rigid and includes at least one compartment to receive golf clubs from a first end of the elongate body.

Preferably the skin is the one as described in any one of the above aspects.

Preferably, the skin is suitable for enveloping the main elongate body of the golf club carrier as described in the any one of the above aspects.

According to a fourteenth aspect, the invention resides in a kit of parts comprising:

a skin as described above in any one of the above aspects; and

an elongated main body as described above in any one of the above aspects, wherein the skin is for enveloping the elongate body.

According to a fifteenth aspect the invention resides in a retail offering, a plurality of skins as described in any one of the above aspects and an elongate body of the golf club carrier as described in any one of the above described aspects.

According to a sixteenth aspect, the invention resides in a method or allowing selective functionality of a golf club carrier, the method comprising providing a main elongate rigid body that includes at least one storage compartment or housing to receive golf clubs from a first end of the elongate body and a plurality of skins each of a flexible construction able to wrap the main elongate rigid body, save for at least the first end of the body.

According to a seventeenth aspect, the invention resides in a set of wheels for use with a golf club carrier, wherein one of the wheels in the set is a first wheel comprising a rim having at least one circumferential protrusion presented on at least one side of the rim at or near at least one of the two edges of the first wheel, wherein the at least one circumferential protrusion is configured to align with at least one complementary notch or groove presented on another wheel of the set which is of the same diameter as the first wheel, wherein the wheels are oriented side by side physically connecting each other or are stacked vertically.

Preferably the wheels can be joined together using a hub, an axle or combination of these.

Preferably, oriented side by side (by joining together) or when stacked vertically, the wheels may be locked together into a single unit for storage.

Preferably, there are two wheels in the set.

Preferably, there are three wheels in the set.

Preferably, all wheels in the set are of the same or substantially the same diameter.

Preferably, the golf club carrier is the one as described above in any one of the above aspects.

Other aspects of the invention may become apparent from the following description which is given by way of example only and with reference to the accompanying drawings.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprises’ or ‘comprised’ or ‘comprising’ is used in relation to the apparatus or to one or more steps in a method or process.

As used herein the term “and/or” means “and” or “or”, or both.

As used herein “(s)” following a noun means the plural and/or singular forms of the noun.

When used in claim and unless otherwise stated, the word ‘for’ is to be interpreted to mean only ‘suitable for’ and not, for example, specifically ‘adapted’ or ‘configured’ for the specific purpose that is stated.

For the purposes of this specification, the term “plastic” shall be construed to mean a general term for a wide range of synthetic or semisynthetic polymerization products, and generally consisting of a hydrocarbon-based polymer.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following description are simply exemplary embodiments of the invention. Hence, specific dimensions and other physical characteristics related to the embodiments disclosed herein are not to be considered as limiting.

For the purpose of this specification, where method steps are described in sequence, the sequence does not necessarily mean that the steps are to be chronologically ordered in that sequence, unless there is no other logical manner of interpreting the sequence.

### BRIEF DESCRIPTION OF THE DRAWINGS

The invention will now be described by way of example only and with reference to the drawings in which:

FIG. 1 shows a golf club carrier according to a first preferred embodiment of the present invention in stowed condition

FIGS. 2a-2h and 3a-3f show one example of various features/components of the golf club carrier of FIG. 1 together with how the golf club carrier of FIG. 1 may sequentially transition into a three wheeled trundler.

FIG. 2i is a schematic view of a trundler mechanism of a golf club carrier according to one embodiment of the present invention showing two struts splayed away from each other in the deployed condition from their proximal ends.

FIG. 4a-4j show examples of wheels for use with the golf club carrier of the present invention.

FIG. 4k shows a schematic cross section view of the three wheels being partially nested in each other and releasably locked together.

FIG. 5a shows side view of the golf club carrier according to a second preferred embodiment of present invention.

FIG. 5b shows a partial view of the golf club carrier of FIG. 5a showing the wheel compartment.

FIG. 5c shows a partial side view of the golf club carrier of FIG. 5a showing one example of a stopper.

FIG. 5d shows an example of how the wheel compartment lid may look like from bottom of the carrier of FIGS. 2a-2h and 3a-3f during closed configuration.

FIG. 5e shows one example of how a separator may be formed inside the golf club carrier of FIGS. 2a-2h and 3a-3f.

FIG. 5f shows a top of a carrier through the opening for at least one golf club compartment and the recessed pockets for the club handles at the bottom.

FIGS. 6a-6e show examples of removable skin or bag according to present invention.

FIG. 6f shows a channel or a groove running the length (or part length) into which a rigid or semi rigid “spine” on the skin could be inserted to provide additional strength/support/stability to the skin.

FIG. 7 shows a golf club carrier according to a third preferred embodiment of the present invention in a fully deployed condition.

FIGS. 8a-8c show one example of a locking mechanism to be used in the golf club carrier of the present invention to lock the storage compartment lid.

FIGS. 9a-9b show one example of a locking system according to one aspect of the present invention that can be applied to the wheel attachment and support mechanism of the golf club carrier of the present invention.

FIGS. 9c-9d show an example of how the wheel attachment and support mechanism of FIGS. 9a-9b can fold down while the golf club carrier is standing upright

FIGS. 9e-9f show an example of how the wheel attachment and support mechanism of FIGS. 9a-9d can be folded to the fully deployed condition.

FIG. 10 shows a golf club carrier according to a fourth preferred embodiment of the present invention in a fully deployed condition.

FIG. 11 is a partial perspective view of the golf club carrier of FIG. 10 showing an example of a braking system according to present invention.

FIG. 12 is a partial view of the storage compartment lid of the golf club carrier of FIG. 10.

FIG. 13a-13e are schematic views sequentially showing the positions of the struts and the brace members when the trundler mechanism transitions from a collapsed or stowed condition to a deployed condition.

### DETAILED DESCRIPTION OF PREFERRED EMBODIMENT(S)

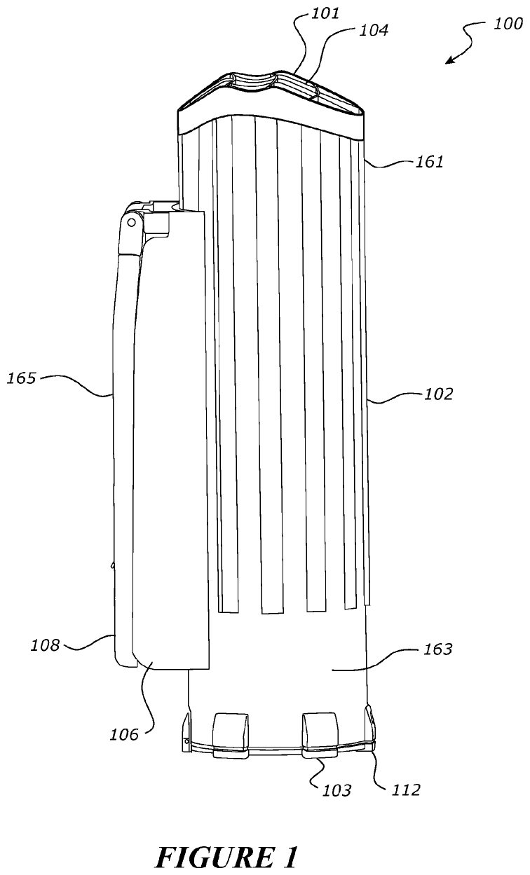

Reference will now be made to the accompanying drawings in which FIG. 1 shows a side elevation view of the golf club carrier 100 according to one preferred embodiment of the present invention.

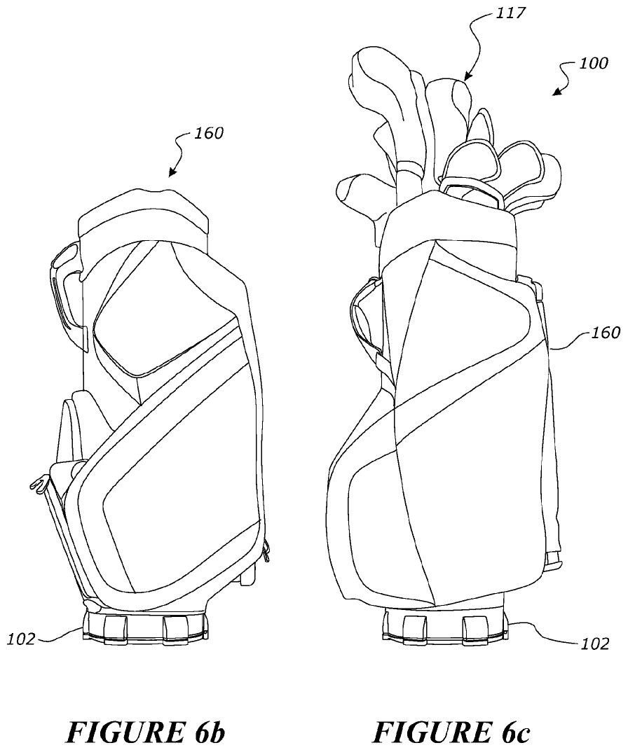

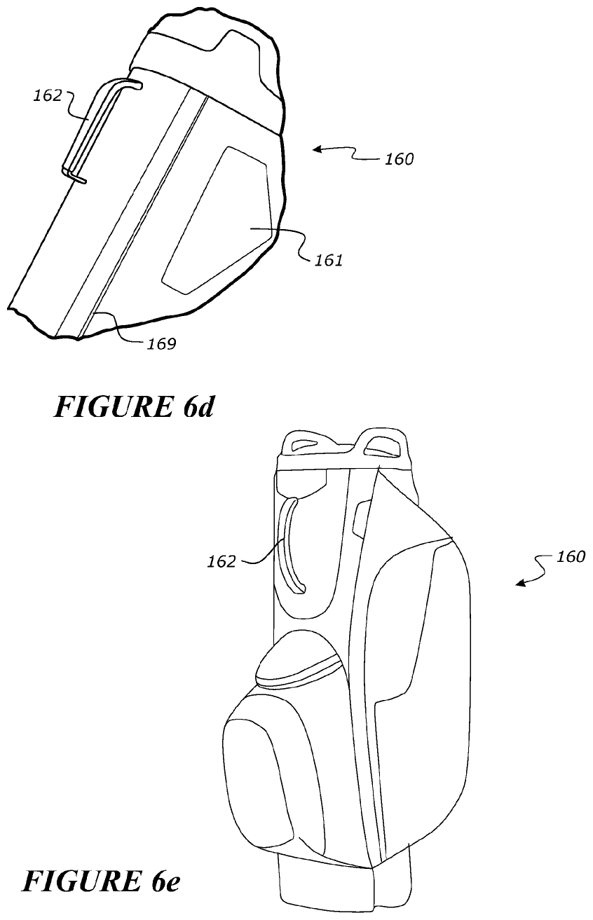

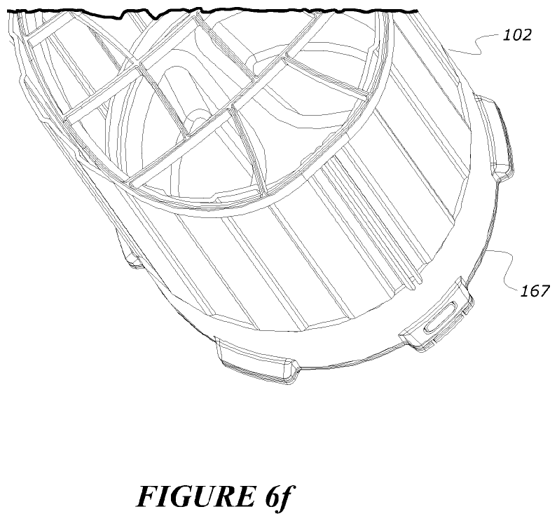

The golf club carrier 100 comprises an elongate body 102 that is preferably of rigid and of unitary construction and having a first end 101 and a second end 103. The body 102 comprises at least one golf club receiving compartment 104. The golf club receiving compartment 104 is adapted to receive and store at least one golf club 117 from the first end 101 as shown for example in FIG. 6c. In FIG. 1, multiple golf club receiving compartments 104 are shown.

This golf club carrier 101 may be configured for storing 13 or 14 golf clubs. Typically, at least one golf club 107 may be inserted into each golf club receiving compartment 104 with handle first but may be loaded club head first instead. A head of a golf club 117 is the part of the golf club which is configured to strike the golf ball, during use. The head of the golf club may be inserted onto the compartment last or is left external of the golf club receiving compartment 104 when the club is stored in the golf club carrier 100. The golf clubs 117 are shown inserted handle first in FIG. 6c.

The carrier 100 optionally comprises a housing or a storage compartment 106. In one embodiment, the storage compartment 106 may be integrally formed on body 101, preferably on the adjacent the body 102 as shown. As shown in FIG. 1, the storage compartment 106 may be presented adjacent the least one golf club receiving compartment 104. In FIG. 1, the storage compartment 106 is shown as protruding out from rest of the body 102. However, rather than protruding out, it may be possible that the storage compartment 106 is formed as a cavity extending inside from the surface of the body, the cavity being separate from the golf club storage compartment 104. Preferably, the length of the body 102 from the first end 101 to second end 103 is no longer than 1000 mm. For example, the length of the body 102 from the first end 101 to second end 103 may be 902 mm.

As shown, the storage compartment 106 may not extend to the bottom region of the body 102. In other words, the storage compartment 106 preferably does not extend to the second end 103 of the body 102. The storage compartment 106 preferably terminates at a distance on the first end side of the second end 103 of the elongate body 102. The distance between the second end 103 and the storage compartment 106 may be at least 50 mm. Alternatively, the distance between the second end 103 and the storage compartment 106 may be at least 100 mm. Having such distance can keep the bottom of the golf club carrier 100 symmetrical (such as circular in cross section) and when a skin is attached to the body 102 in a manner (as will be described later), the golf club carrier 100 can look like a traditional golf bag. This also means that when strapping the golf club carrier 100 to a motorised golf cart, the base or bottom region of the carrier 100 can function similar to that of a traditional golf bag without impediments.

The golf club carrier 100 of the embodiment shown in FIG. 1 can be deployed into trundler or a trolley.

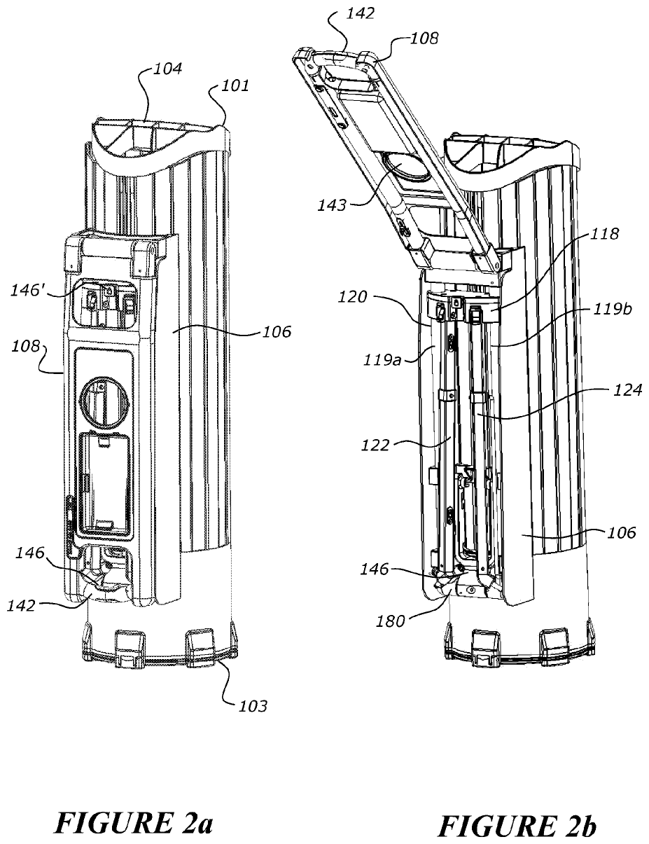

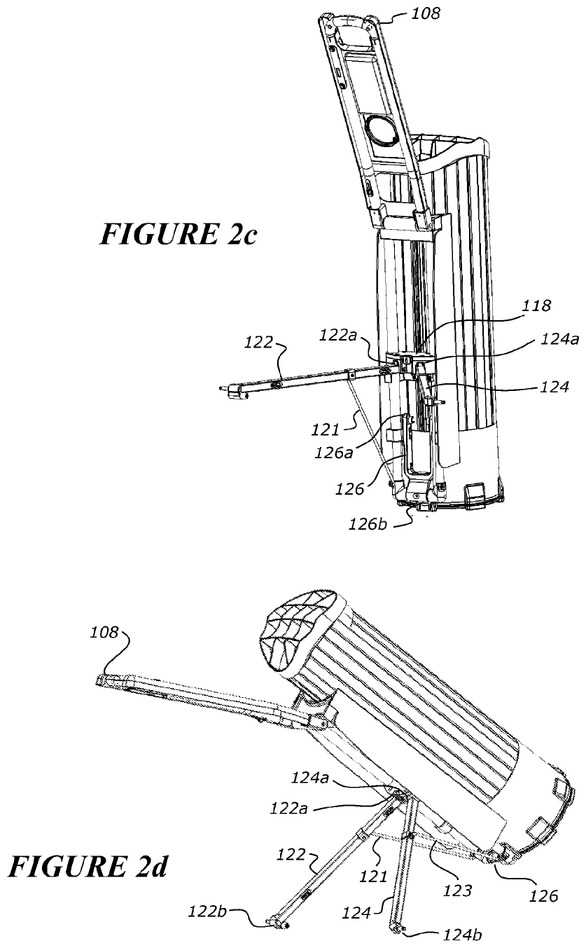

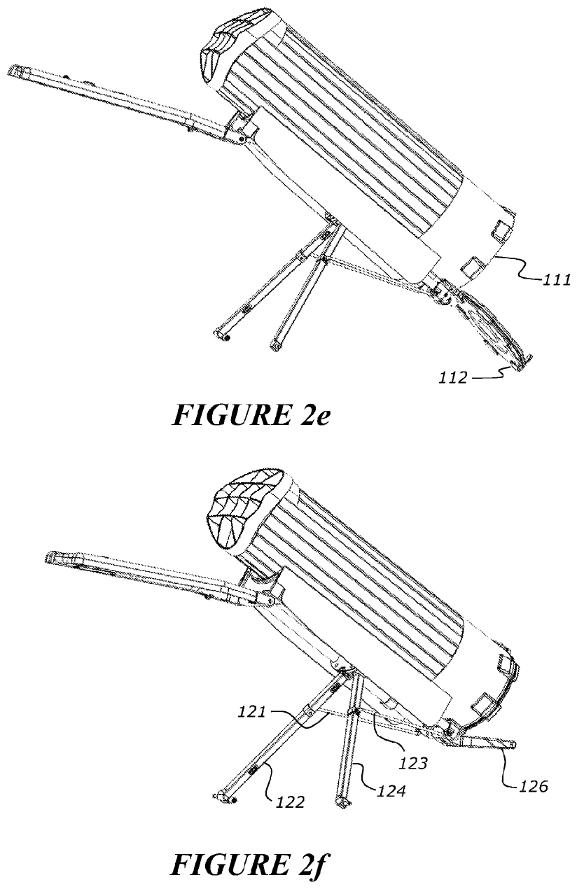

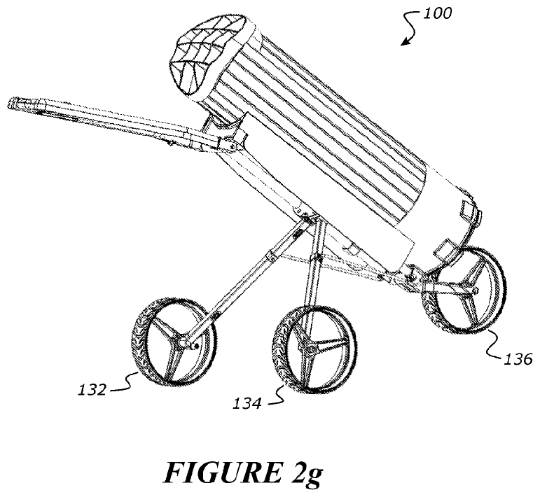

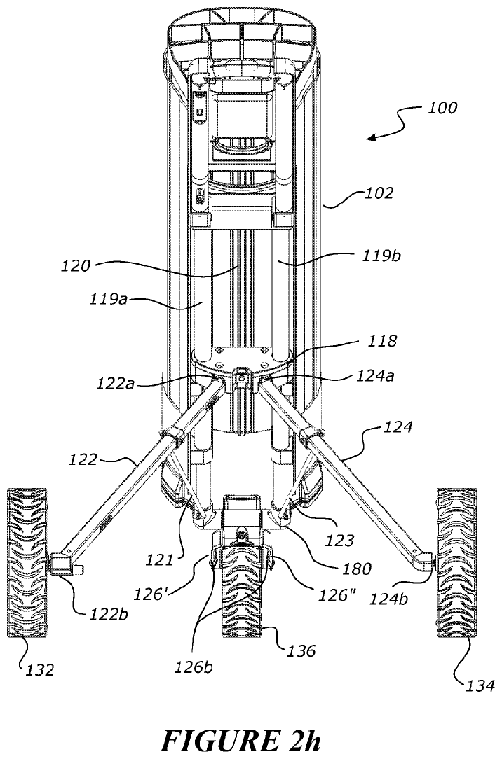

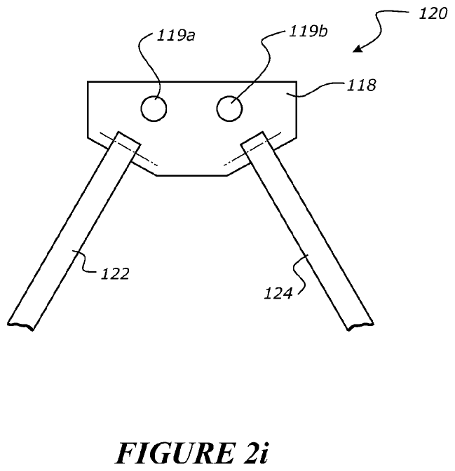

FIGS. 2a to 2h show an example of how the golf club carrier 100 of FIG. 1 can sequentially transition into a three wheeled trundler. This will be described later in the specification in more detail.

The golf club carrier 100 preferably comprises a storage compartment lid 108 which when closed conceals or encloses (or at least substantially conceals or encloses) the storage compartment 106 as shown in FIG. 2a and which when opened reveals the storage compartment 106 as shown in FIG. 2b. The storage compartment lid 108 is preferably of a pivotable arrangement as shown in the FIGS. 2a to 2h.

As shown in FIG. 2b (also see FIG. 2h), the storage compartment 106 is configured to stow a trundler mechanism 120 including at least two struts 122, 124. Preferably, the length of each strut is no longer than 550 mm. For example, the length of each strut may be 471 mm (or about 471 mm). The struts 122, 124 is able to receive wheels 132, 134 to allow the carrier 100 to be transported over ground as shown in FIGS. 2g and 2h. The trundler mechanism 120 may be able to be moved from its stowed/folded/collapsed condition with the struts in the compartment 106, i.e. inside the compartment, as shown in FIG. 2a to a deployed condition as shown in FIGS. 2g and 2h where the two struts 122, 124 are presented in a manner extending from their proximal ends 122a, 124a away from the body 102. The wheels 132, 134 may be able to be received or secured to or near the distal ends 122b, 124b of the struts 122, 124. As it can be seen from the figures, the proximal ends 122a, 124a are the ends that are proximal to (or near) the elongate body 102 when in the deployed condition, and the distal ends 122b, 124b are the ends that are distal to (further/away from) the elongate body when in the deployed condition.

The trundler mechanism 120 and/or the struts thereof may be permanently attached to the storage compartment at or near the proximal ends 120a, 120b of the struts. Alternatively, trundler mechanism 120 and/or the struts thereof may be permanently attached to the elongate body 102 at or near the proximal ends 122a, 124a of the struts 122, 124.

The struts 122, 124 may be of telescopic arrangement and therefore may be adjustable in length. Alternatively, the struts 122, 124 may be not adjustable in length. The struts 122, 124 may be in the form of rods or tubes.

The storage compartment 106 may also stow a wheel attachment and support mechanism 126. The wheel attachment and support mechanism 126 may be able to be moved or pivoted such as by a hinge from a stowed condition as shown in FIGS. 2a-2b in the storage compartment 108 to a deployed condition as shown on FIGS. 2c-2h. In the fully deployed condition as shown in FIGS. 2e-2f, the wheel attachment and support mechanism is presented in a manner extending from its proximal end 126a from the elongate body 102.

At least one wheel 136, which in the example shown, is a front wheel or a third wheel may be able to be secured to a distal end 126b of the wheel attachment and support mechanism 126. Hence, in the example shown, the wheel attachment and support mechanism is a front wheel attachment and support mechanism. As it can be seen from the figures, the proximal end 126a of the wheel attachment and support mechanism 126 is the end that is proximal to (or near) the elongate body 102 when in the deployed condition, and the distal end of the wheel attachment and support mechanism is the end that is distal to (further/away from) the elongate body when in the deployed condition.

The wheel attachment and support mechanism 126 in this preferred embodiment is a fork as shown in the figures. Even more preferably, the wheel attachment mechanism 126 may be or may comprise a telescopic fork so that that is adjustable in length.

The wheel attachment and support mechanism 126 may be dependent from the elongate body 102. The wheel attachment and support mechanism 126 may be configured to be move (preferably pivoted) between (a) a stowed condition where the wheel attachment and support mechanism 126 is located more proximal the elongate body and (b) a deployed condition where the wheel attachment and support mechanism 126 is presented in a manner extending from the elongate body 102 with its distal end 126b at a position that is more distal the elongate body 102 than in the stowed condition, and in a manner to be able to receive and secure a wheel that, in cooperation with the first and second wheels 132, 134, allow the carrier 100 to be rolled over ground.

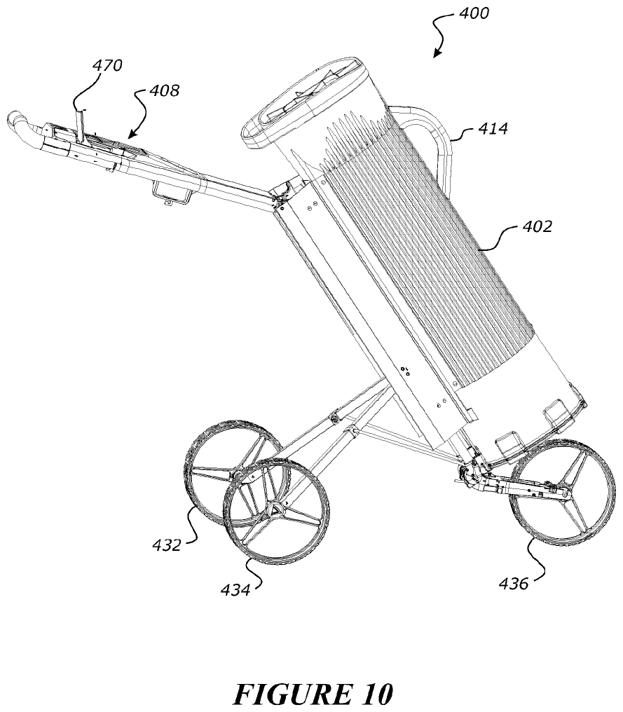

The body 102 may include at least one handle similar to the handle 414 as shown in an embodiment of FIG. 10. Such handle can assist in lifting the body 102. The handle 114 may be formed (preferably integrally formed) with the exterior of the body 102.

The body 102 may be made from plastics, polyethylene, polyvinyl chloride (PVC) or other suitable rigid material. The body 102 may be from a suitable water-resistant material as the carriers 100 designed to be used outdoors in all weathers.

In the preferred embodiments, the body 102 is shown as elongate and the length may be substantially similar to that of the golf clubs 117. The body 102 may be substantially cylindrical in shape with its diameter or width greater than the wheel diameter of the wheels 132, 134, 136. Alternatively, the body 102 may be polygonal shaped in cross-section. Preferably, the length of the body 102 from the first end to second end is 902 mm (or about 902 mm).

As shown in FIGS. 2c and 2d, the trundler mechanism 120 may comprise at least two brace members 121, 123. Each of the brace members 121, 123 may extend between a first end and a second end. Preferably, the length of each brace member is no longer than 400 mm. For example, the length of each brace member is 315 mm (or about 315 mm).

The first end of each brace member 121, 123 may be mounted/secured or adapted to be mounted/secured to one of the struts 122, 124 as shown. Preferably, each strut 122, 124 may only mounted/secured or adapted to be mounted/secured with one brace member. As shown in FIG. 2d, the first end of the first brace member 121 is mounted/secured to the first strut 122 and the first end of the second brace member 123 is mounted/secured to the second strut 124. The second ends of the brace members 121, 123 may be mounted/secured or adapted to be mounted/secured with the wheel attachment and support mechanism 126 or with a secondary slide 180. Alternatively, the second end of the brace members 121, 123 may be mounted/secured or configured to be mounted/secured with the elongate body 102 or the rails 119a, 119b. The brace members 121, 123 serve to extend and retract the telescopic fork of the wheel attachment and support mechanism 126 and can provide extra support to the struts when the trundler mechanism 120 is in the deployed condition.

Preferably, the first end of each brace members is mounted/secured or adapted to be mounted/secured to the struts 122, 124, preferably at a point that is closer to the proximal end 122a, 124a of each strut 122, 124. Preferably the brace members 122, 124 at their proximal end are attached to the body 102 and at their distal end 122b, 124b are attached to the respective strut. The brace members 121, 123 may be mounted/secured to a respective strut intermediate of the ends of the strut.

Preferably, such attachment or mounting of the brace member 121, 123 may be via fixed or removable arrangement but may be via pivotal, hinged and/or slidable arrangement instead. The mounting of the second ends of the brace members 121, 123 may be via pivotal, hinged and/or slidable arrangement, but may be fixed or removable arrangement instead.

The brace members 121, 123 may be elongate members such as rods or tubes. In the stored condition, the brace members 121, 123 may be parallel to each other and preferably parallel to the elongate direction of the body 102.

The brace members 121, 122 may or may not be transitionally mounted/secured to the body 102. Similarly, the brace members 121, 123 may or may not be translationally mounted/secured to a respective strut.

As mentioned above, the storage compartment 106 is optional and if the storage compartment 106 is not present the trundler mechanism 120 may be permanently attached to the exterior of the body 102. Similarly, the storage compartment lid 108 may also be optional.

As shown in FIG. 2e, the elongate body 102 may comprise a wheel compartment 111. Preferably, the length of the wheel compartment is 230 mm (or about 230 mm) from the second end 103 of the golf club carrier 100. The wheel compartment 111 may be located at the second end 103 of the elongate body 102 as shown in FIG. 2e. The golf club receiving compartment(s) 104 may extend to the wheel compartment 111.

The wheel compartment 111 may be configured to store detachable wheels 132, 134, 136. As shown, the wheel compartment 111 may be located (preferably integrally formed) at a bottom region of the elongate body 102 that is proximal to the second end 103. The wheels 132, 134, 136 when stored at the compartment will not need to be carried separately. This reduces the prospect that the wheels 132, 134, 136 get misplaced or lost.

The elongate body 102 may comprise the wheel compartment lid 112. The wheel compartment lid 112 is preferably pivotally mounted such as by a hinge to the elongate body 102 which when closed substantially or fully encloses the wheel compartment 111 at the bottom region as shown in FIG. 2d and which when open reveals the wheel compartment 111 as shown in FIG. 2e. The wheel compartment lid 112 or cover preferably provides access to the wheel compartment 111 from the bottom region of the elongate body 102.

The wheel compartment lid 112 may be rigid or non-rigid such as made out of a fabric.

Instead of being pivotally mounted to the body 102, the wheel compartment lid 112 may instead be temporarily secured at or near the second end 103 to the body by a locking mechanism at or near the second end 103. For example, the wheel compartment lid 112 may be secured on to the body 102 by a snap fit mechanism, screwed on, or with a latch etc. The wheel compartment lid 112 may even comprise a zip for connecting wheel compartment lid 112 with body 102.

The golf clubs 117 may be stored in the carrier 100 using the entire length of the carrier 100, including the wheel compartment 111.

A golf club carrier 100 with a wheel compartment 111 within or integral with the body 102 may be advantageous over a carrier which has an external compartment configured to store detachable wheels. An external compartment is generally more bulky and less aesthetically pleasing and the wheels generally take up space where other golf equipment would usually reside. The wheel compartment 111 of the present invention allows the storage of the wheels in a compact and unobtrusive manner yet without compromising the effective club compartment length.

The wheel compartment 111 may be configured also store other golf equipment such as clothing, golf balls, battery etc. without hindering the length of usable space length for golf clubs 117 in the golf club receiving compartment 104.

The wheels 132, 134, 136 when attached as shown in FIGS. 2g and 2h may aid in transport of the carrier 100. In the transporting condition as shown in FIGS. 2g and 2h, the wheels 132, 134, 136 may be configured to rotate and bear at least some of the weight of the body 102. The wheels 132, 134, 136 may support the elongate body above a horizontal or substantially horizontal surface (e.g. ground) at an incline of between 40 and 90 degrees.

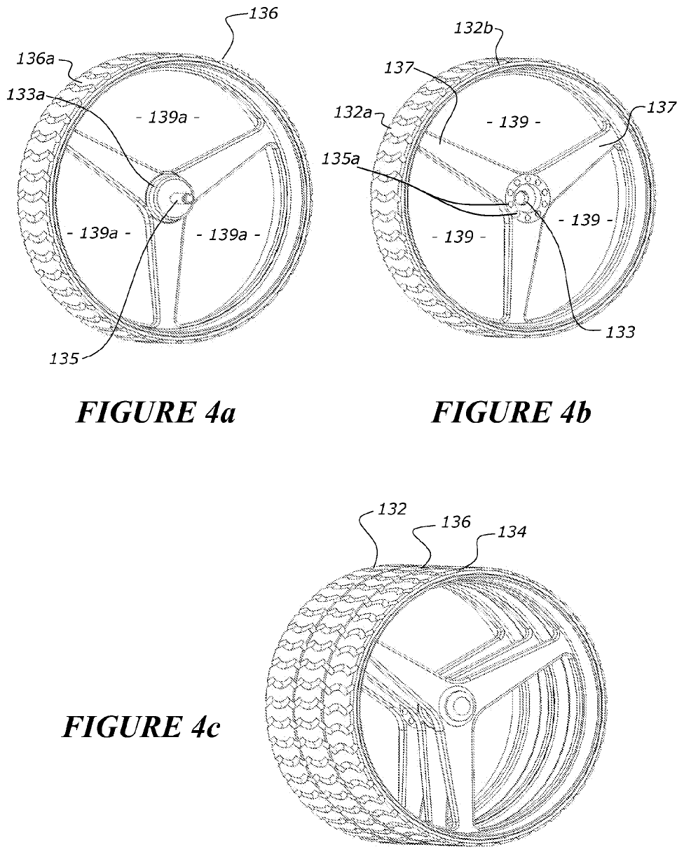

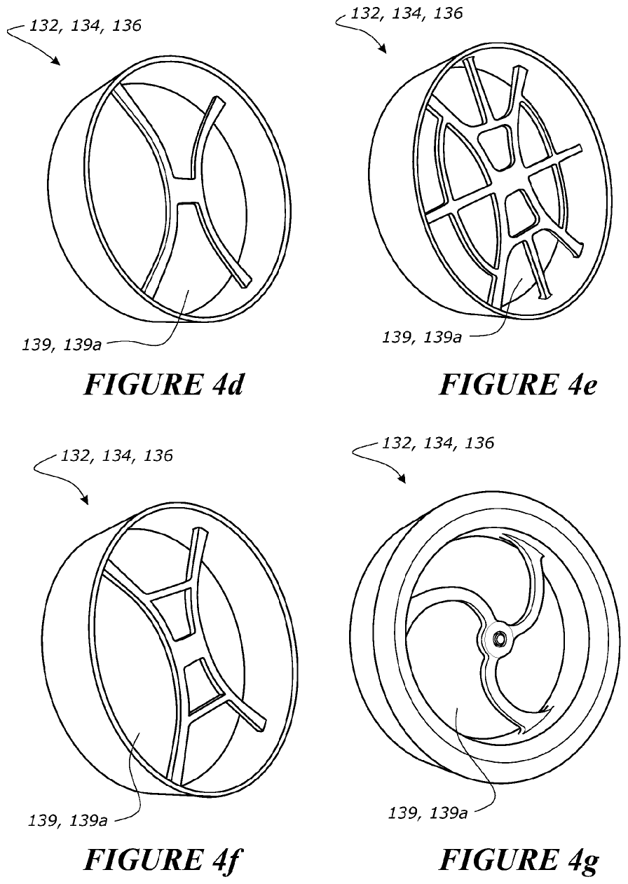

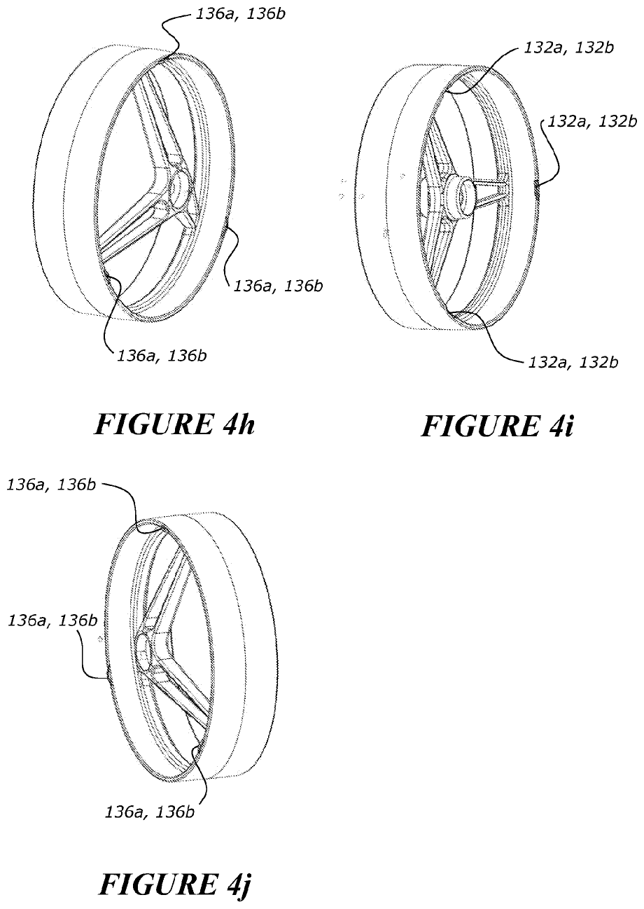

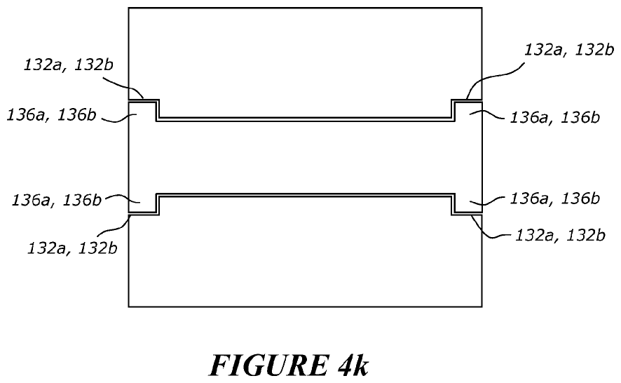

FIG. 4a shows a perspective view of a front wheel 136 that may be used to mount with the distal end 126b of the fork or the wheel attachment and support mechanism 126.

As shown in FIG. 4a, the front wheel 136 may comprise a central hub 133a having an axel or pin 135 extending out from both sides of the central hub 133. The pin 135 may be formed as two separate pins extending out in the same way from both sides of the central hub 133.

The extended part of the pin 135 of front wheel 136 may be adapted to connect to the distal end of the each of the two parallel arms that are projected portions 126′, 126″ of the fork 126 so that the front wheel 136 may be removably mounted/secured between the two projections or arms 126′, 126″ of the fork 126 as shown in FIGS. 2g and 2h. The arms 126′, 126″ are spaced apart and parallel arms and the at least one wheel which in this example is a front wheel 136 is adapted to be received and secured between the two arms 126′, 126″ of the fork. The front wheel 136 may be removably mounted/secured with the fork 126 using many other suitable means. As shown in FIG. 4b, the front wheel 136 may have webs or spokes 137a extending preferably radially from the central hub 133a to the rim of the front wheel 136. There may be one web or spoke but plurality of webs or spokes is preferable. The webs or spokes 137a together with the central hub 133a and rim define the openings 139a through the front wheel 136.

FIG. 4b shows a perspective view of an example of one of the rear wheels 132, 134 that may be used to mount with the distal end 122b, 124b of a strut 122, 124. As shown in FIG. 4a, each rear wheel 132, 134 may be designed with flanged wheel bearings to quick connect to the distal end 122b, 124b of a strut 122, 124.

As shown in FIG. 4b, the rear wheels 132, 134 may comprise a central hub 133.

The rear wheels 132, 134 may be removably mounted/secured with the distal ends 122a, 124b of the struts 122, 124 using many suitable means. Each rear wheel 132, 134 may have webs or spokes 137 extending preferably radially from the central hub 133 to the rim of the wheel 132, 134. There may be one web or spoke but plurality of webs or spokes is preferable. The webs or spokes together with the central hub 133 and rim define the openings 139 through the wheel.

As shown, each of the front and rear wheels may have circumferential notch(es) (or groove(s)) or corresponding complementary protrusions on each side of the rim. For example, the front wheel 136 may have circumferential protrusion(s) 136a, 136b on each side of the rim and each of the rear wheels 132, 134 may have corresponding complimentary circumferential notches 132a, 132b on each side of the rim. When the three wheels 132, 133, 134 are oriented side by side as shown in FIG. 4c or are stacked vertically (inside the wheel compartment 111 or at any surface), the front wheel 136 may be placed between the two rear wheels 132, 134 so that the protrusions 136a, 136b of the front wheel 136 may align with the corresponding complementary notches 132a, 132b of the two rear wheels 132, 134 thereby facilitating the releasable coupling or nesting of the wheels 132, 134, 136. Also, as shown in FIG. 4c, the pin 135 extending on each side of the front wheel 136 may accept the rear wheels 132, 134 when nested/coupled together for storage or otherwise. So, the wheels 132, 134, 136 can be joined together using a hub, axel or a combination of these. Preferably, when joined together side by side as shown in FIG. 4c or when stacked vertically, the wheels 132, 134, 136 may be locked together as a single unit for storage or otherwise.

Instead of the rear wheels 132, 134 having the circumferential notches 132a, 132b, the front wheel 136 may have circumferential notches and rear wheels 132, 134 may have corresponding complementary circumferential protrusions. Alternatively, one side of the rim of each wheel may have a protrusion, and the other side may have a corresponding notch. Hence, any permutations or combinations of notches and protrusions are possible as long as nesting of the three wheels is facilitated.

FIGS. 4h and 4j show an example of protrusions 136a, 136b formed on at least one side of the rim. FIG. 4i show an example of notches or groves 136a, 136b formed on at least one side of the rim. As shown, the protrusions can be configured to be received by complementary features which in this example is are notches or grooves 132a, 132b formed on another wheel to facilitate at least partial nesting and releasable locking of the wheels 132, 136. FIG. 4k shows a schematic cross section view of the three wheels being partially nested in each other and releasably locked together. The notches or groves 132a, 132b are sized and shaped to receive protrusions 136a, 136b. Although, FIGS. 4h-4j show three protrusions and three complementary notches, there may be at least one or more than three protrusions or notches in the wheels.

Therefore, the golf club carrier 100 may comprise a set of wheels 132, 134, 136. One of the wheels in the set may comprise a rim having at least one protrusion 136a, 136b that may be presented on at least one side of the rim at or near at least one of the two edges of the first wheel. The protrusion(s) 136a, 136b, may be configured to align with at least one complementary notch or groove 132a, 132b presented on another wheel of the set which is of the same diameter as the first wheel. The wheels can be oriented side by side physically connecting each other or are stacked vertically.

As shown, the wheels can also be joined together using a hub, an axle or combination of these.

When oriented side by side (by joining together) or when stacked vertically, the wheels may be locked together into a single unit for storage.

In summary, at least one of wheels comprise at least one protrusion 136a, 136b formed on at least one side of its rim. The protrusion(s) 136a, 136b of said at least one wheel may be configured to be received by at least one complementary feature formed on the rim of the other for the releasable coupling of the at least two wheels. Preferably, the complementary feature(s) are notch(es) or groove(s) 132, 132b that are sized and shaped to receive the protrusions. Preferably, each of the wheels comprises spokes and the spokes of the at least two wheels are aligned when the at least two wheels are coupled together. The wheel compartment 111 may be configured to store three wheels in a coaxial manner. At least two of the three wheels may at least partially nest with the third wheel when stored inside the wheel compartment 111.

Preferably, the at least two of the three wheels at least partially nest with the third wheel when stored inside the wheel compartment.

Having such nesting and/or locking arrangement at least may be advantageous as that can allow the three wheels 132, 134, 136 to be quickly stored and retrieved using one hand and reduces risk of the wheels 132, 134, 136 from easily falling off the hand during such storage and retrieval process.

Alternatively, the wheels 132, 134, 136 may be designed such that at least two wheels nest or partially nest inside each other, for example when stored inside the wheel compartment 111. Although, three wheels 132, 134, 136 are shown, there may be only two wheels a set. Preferably, all wheels 132, 134, 136 are of the same or substantially the same diameter. Preferably, the wheel compartment 111 is configured to store three wheels in a coaxial manner.

As shown in FIGS. 4a-4c, in one embodiment, each wheel 132,134, 136 has three openings to form a three spoke wheel, where the spokes extend from a central hub 139, 139a. However, as shown in FIGS. 4d-4g, the wheels 132, 134, 136 may comprise a range of different shaped openings 139, 139a. The different shaped openings 139, 139a may correspond to varying types and numbers of golf clubs 117 to be stored. Profiles of corresponding golf club receiving compartments may correspond to the different shaped openings 139, 139a of the wheels 132, 134, 136. The rims of the wheels 132, 134, 136 as shown in FIGS. 4d-4g may also have circumferential protrusions and/or notches/grooves and/or pin(s) similar to the wheels as described above with reference to FIGS. 4a-4c.

The wheels 132, 134, 136 may be stored in range of different configurations within the wheel compartment 111. Preferably, the wheels 132, 134, 136 are stacked up the length of the golf club carrier 100. Alternatively, the wheels 132, 134, 136 may be stored side by side. In one alternative form, the wheel compartment may only store rear wheels 132, 134 and the front wheel 136 may be permanently mounted/secured to the body 102 or to the wheel attachment and support mechanism 126.

As it can be seen from FIG. 4c, the spokes of the wheels 132, 134, 136 are aligned when the wheels 1232, 134, 136 are coupled and releasably locked together. Since, the spokes of the wheels 132, 134, 136 are aligned the openings are consequently aligned. This allows pockets of separator (described later) to easily pass through all three wheels 132, 134, 136 without to allow easy storage of the wheels 132, 134, 136 inside the wheel storage compartment 111.

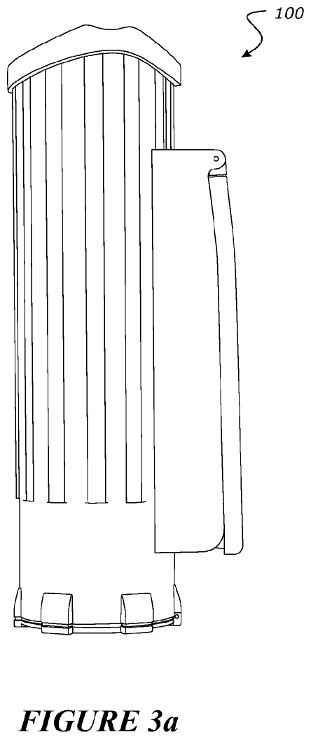

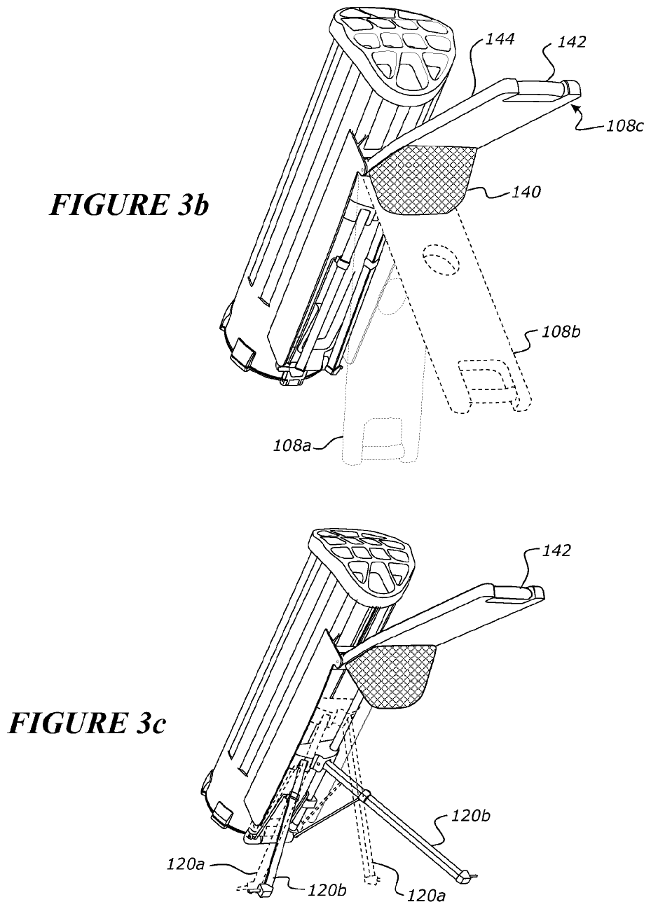

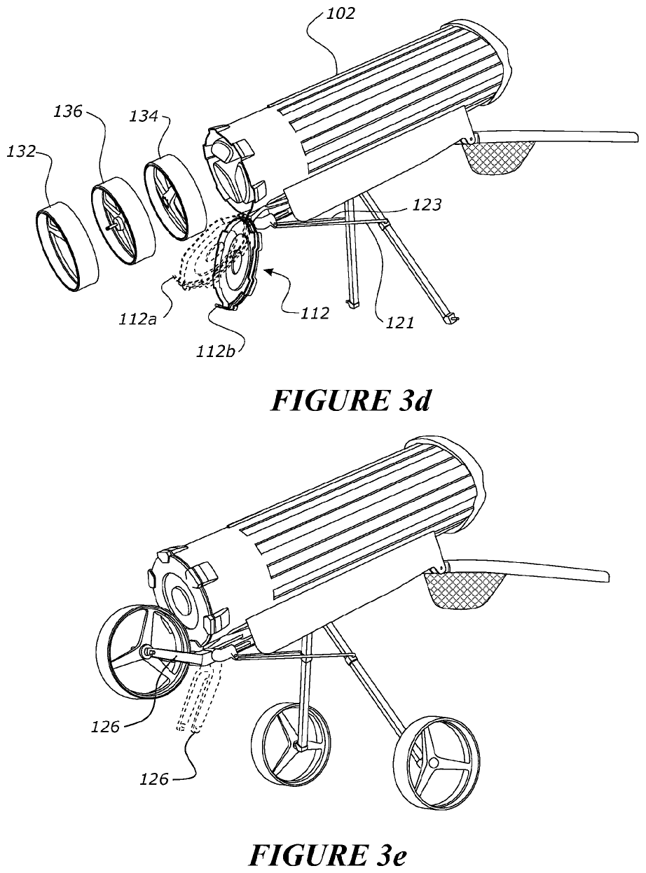

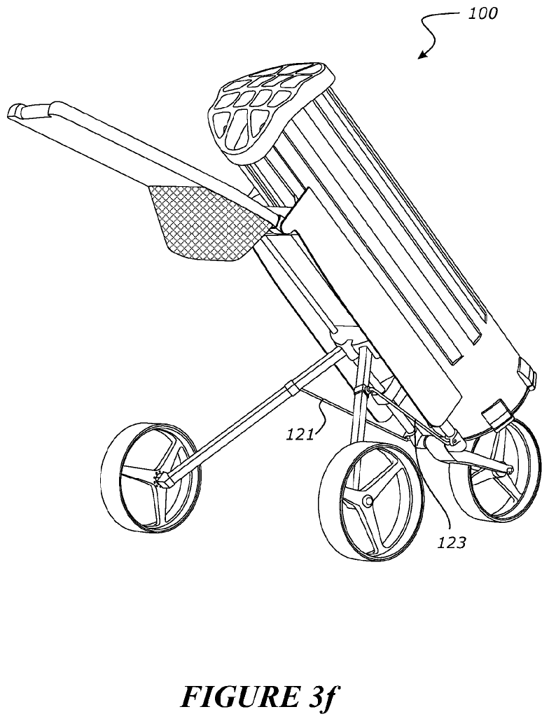

FIGS. 3a-3f show the same preferred embodiment of the golf club carrier 100 as shown in FIGS. 1 and 2a-2h. For the sake of clarity, some of the features/elements that are shown in FIGS. 1 and 2a-2h are not shown in FIGS. 3a-3f. A mesh pocket 140 that is not shown in FIGS. 1 and 2a-2h for the sake of clarity can be seen in FIGS. 3a-3f.

The golf club carrier 100 according to one preferred embodiment of the present invention will now be described in further details together with deploying of the golf club carrier 100 into the three-wheel trundler.

One preferred example of deploying the golf club carrier 100 into a three wheel trundler is shown in FIGS. 2a to 2h and also in FIGS. 3a to 3f in a systematic order.

When the wheels 132, 134, 136 are stored inside a wheel compartment 111 and are concealed by the wheel compartment lid 112 and the struts 122, 124 are stowed inside the storage compartment 106 and concealed by the storage compartment lid 108, the golf club carrier 100 looks similar to what is shown in FIGS. 2a and 3a. When a skin 160 is attached to the golf club carrier 100 the golf club carrier 100 looks similar to what is shown in 6a, 6b, 6c and 6e. As shown, the struts 122, 124 may extend in (or parallel to) the elongate direction of the body 102 when in the stowed condition.

In order to deploy the carrier 100 into a three-wheel trundler, the storage compartment lid 108 may first be moved into the position as shown in FIGS. 2b and 3b, thereby revealing the inside of the storage compartment 106. There may be a locking mechanism button 146 on the inside of the gripping portion 142 or in other suitable location as shown in FIG. 2a. The button 146 may unlock the gripping portion 142 allow the storage compartment lid 108 and consequently also the gripping portion 142 to be set at the preferred height with a press of the button 146. In other words, the gripping portion 142 (handle) may contain a button 146 which when depressed allows the angle of the gripping portion 142 and the storage compartment lid 108 to be adjusted upwards or downwards.

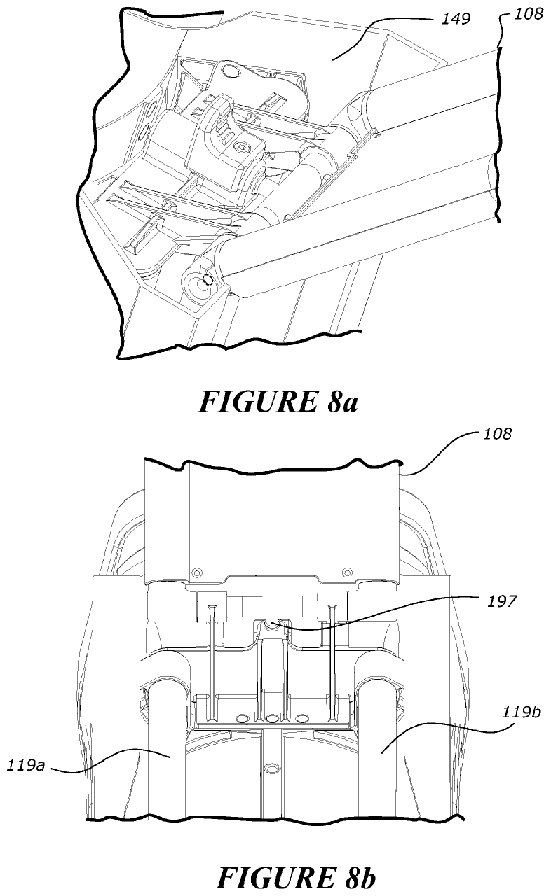

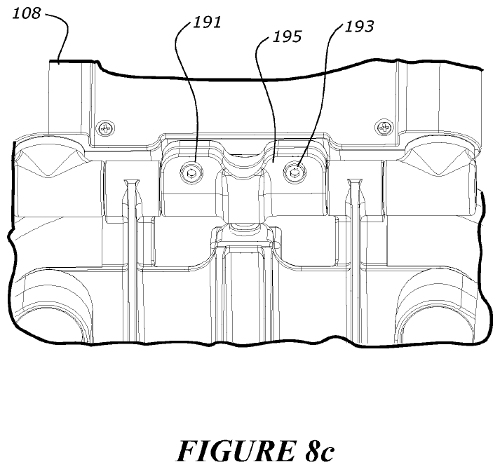

Instead of a button 146, the locking mechanism may be in the form as shown in FIG. 8a-8c. Instead of having to set and adjust the desired angle of the handle/gripping portion 142 and the storage compartment lid 108 every time the storage compartment lid and the gripping portion 142 is deployed, use of locking mechanism 149 shown in FIGS. 8a-8c, only requires the user to set the desired angle of the handle 102 and the storage compartment lid 108 once. Once set to be deployed at a particular angle, the handle 102 and the storage compartment lid 108 will always be deployed at that angle unless the locking mechanism is reset by the user. As shown in FIG. 8c, the locking mechanism 149 may comprises two screws 191, 193 which tighten the adjustable clamp 195 to a desired/preferred angle rotating the hole that is locked by a locking pin 197. FIG. 8b is same as FIG. 8c but with the locking clamp 195 removed. Therefore, the angle of the storage compartment lid can be adjusted and set relative to the elongate direction.

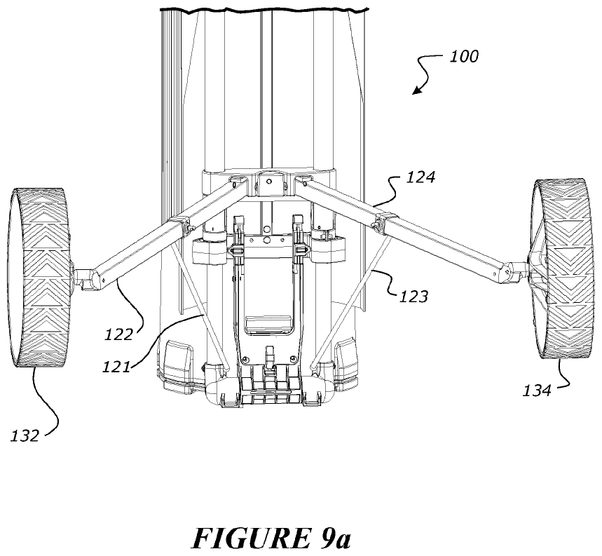

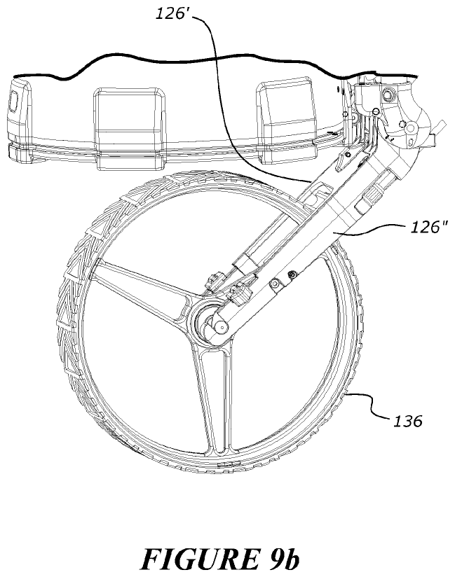

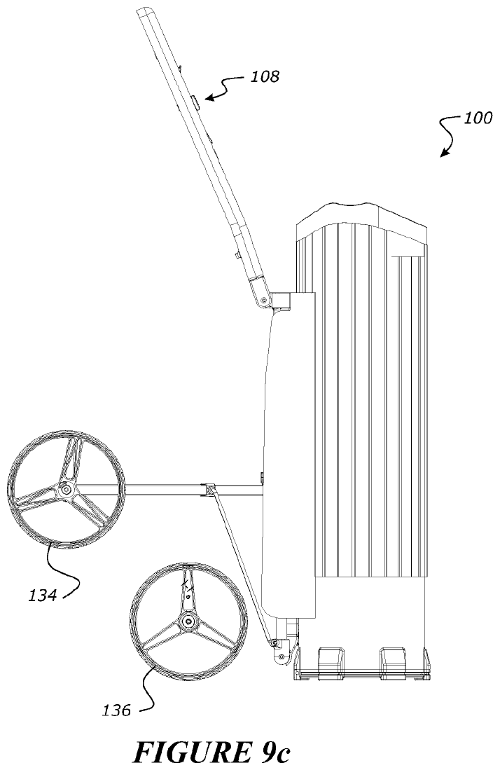

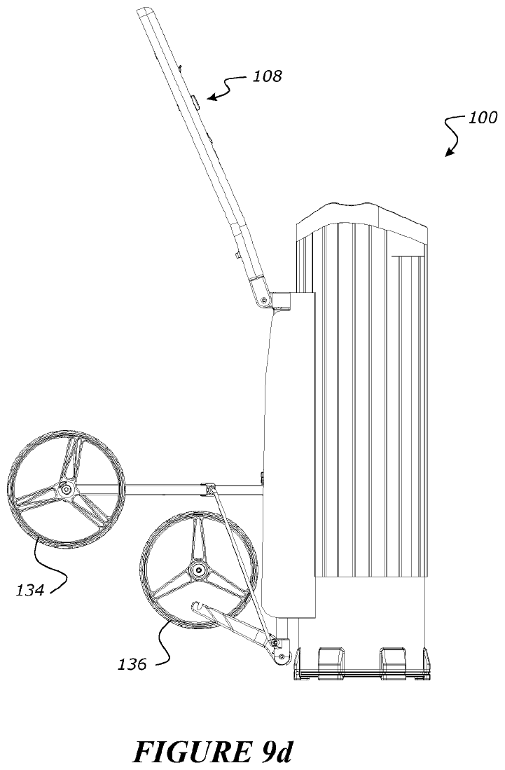

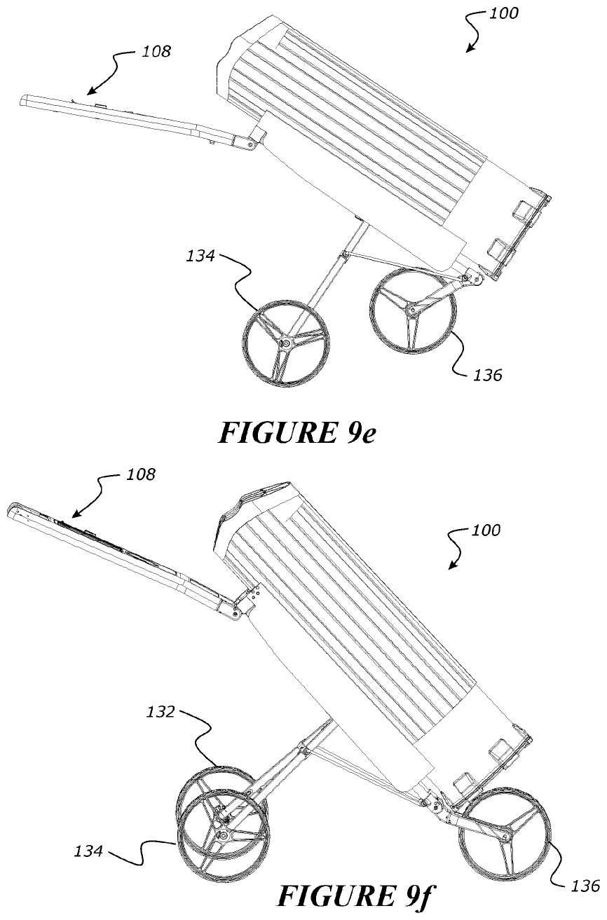

As shown in FIGS. 9a and 9b, a locking mechanism may also be applied to the distal end of the wheel attachment and support mechanism 126 in the deployed position to enable a quick attachment of the front wheel from the back when attaching the two rear wheels. As shown in FIGS. 9c-9d, the wheel attachment and support mechanism 126 can fold down while the golf club carrier 100 is standing upright and the user can quickly attach all three wheels 132, 134, 136 from the back of the golf club carrier 100. Once the wheels 132, 134, 136 are attached, the wheel attachment and support mechanism 126 may then folded back to the deployed condition as shown in FIGS. 9e-9f.

Referring to FIGS. 3a and 3b, the storage compartment lid 108 may be pivotally moved from the closed position to a partially opened position 108a, then to a more opened position 108b and finally to a fully opened position 108c. Preferably, when in the fully opened position 108c, the storage compartment lid 108 locks into place so that it does not accidently return back or tend to return back towards the direction of the closed position shown in FIG. 3a.

As shown in FIGS. 2c and 2d, the struts 122 and 124 may then be moved preferably pivotally extending from their proximal ends 122a, 124a from the body 102. Referring to FIGS. 3b and 3c, the struts 122, 124 may be pivotally moved from the stowed position shown in FIG. 3b to a partially extended position 120a and finally to a fully extended position 120b as shown in FIG. 3c. Preferably, the struts 122, 124 extend at an acute angle to the elongate direction of the body when on the deployed condition, as shown. Preferably, when in the full or desired retracted position, the struts 122, 124 lock into place so that they do not accidently return back or tend to return back towards the initial stowed position.

One example of a trundler mechanism will now be described with reference to FIGS. 2a-2h. The trundler mechanism 120 may comprise a track. In the example shown, the track is in the form of two parallel and spaced apart rails 119a, 119b. A slide or a slidable collar 118 is mounted/secured to the track, i.e. to the rails 119a and 119b to slide along the rails. Preferably, the collar 118 slides in a direction parallel to the elongate direction of the elongate body between a first position and a second position. The collar 118 may slide the rails 119a, 119b in a direction that is parallel to the elongate direction of the body 102. The proximal end 122a, 124a of each strut may slide with the collar in a direction parallel the elongate direction of the body 102. The trundler mechanism may comprise at least the track 119a, 119b, the collar 118 and the struts 122, 124.

The proximal ends 122a and 124a of the struts 122, 124 may be pivotally mounted to the collar 118. In order to move the struts 122, 124 to the extended position, the collar 118 may be caused to slide down from a position as shown in FIG. 2b to a position as shown in FIG. 2c and the struts 122, 124 may be moved (or pivoted) to the extended position. Therefore, the collar 118 may be near the first end 101 of the body 102 when the struts are in their stowed condition and are more proximal to the second end 103 of the body 102 when the struts are in their deployed position. Additionally, or alternatively, the proximal ends 122a and 124a of the struts 122, 124 may be pivotally mounted to the track 119a, 119b in a manner to be able to pivot relative to the track 119a, 119b.

The trundler mechanism 102 is reconfigurable between a stowed condition and a deployed condition. In the stowed condition, each strut 122, 124 is positioned with its distal end 122b, 124b proximal the elongate body when the collar 118 is in the first position. In the deployed condition when the collar 122, 124 is in the second position where each strut is presented with its distal end more distal from the elongate body than when in the stowed condition in a manner extending away from the proximal end from the elongate body each strut able to receive and secure a wheel at or near the distal end of each strut to allow the carrier to be transported in a rolling manner over ground.

The first position of the collar 118 is when the collar is in the position that is more proximal to the first end 101 of the elongate body. Similarly, the second position of the collar is when is more proximal to the second end 103 of the elongate body 102.

In the stowed condition the two struts 122, 124 may be parallel to each other. However, in the deployed condition, two struts 122, 124 the struts 122, 124 splay away from each other in the deployed condition from their proximal ends. In other words, the struts 122, 124 spread apart from each other and are not parallel to each other in the deployed condition as shown in FIGS. 2h and 2i. As shown in FIG. 2i, the proximal ends may be mounted to the slider with non-parallel pivot axes to ensure the splaying of the legs.

As mentioned above, the golf club carrier may optionally comprise the storage compartment 106. The storage compartment may be configured to stow the trundler mechanism 120. The storage compartment 106 may be presented adjacent the elongate body 102. The storage compartment 106 may be presented adjacent either inside or outside the elongate body 102. In the stowed condition of the trundler mechanism 102, the struts 122, 124 may be positioned to locate in the storage compartment. Similarly, in the deployed condition of the trundler mechanism 120 each of the struts 122, 124 may be presented extending, out of the storage compartment (preferably from the collar in the storage compartment), in a manner extending away from the elongate body.

Preferably, the struts 122, 124 are of telescoping arrangement and are adjustable in length. Alternatively, the struts 122, 124 are non-adjustable in length, especially when mounted/secured to the collar 118 of such slidable arrangement.

Once in the desired or fully extended position, the struts 122, 124 and the collar 108 may be locked into place so that they do not accidently return back or tend to return back towards the initial stowed position. The collar 118 may be able to lock to each rail 119a, 119b. As shown in the figures, one end of each of the brace members 121, 123 may be mounted/secured to the wheel attachment and support mechanism 126 (or pivotally to the U-shaped member 180 that connects the two rails 119a, 119b and the wheel attachment and support mechanism 126 (see FIG. 2h). The other end of each of the brace members 121, 123 may be mounted/secured to the struts 122, 124, preferably at the portion of each strut 122, 124 (which can be telescopic strut) that is proximal to the body 102. Since, the struts 122, 124 and the wheel attachment and support mechanism 126 are all configured to pivotally move with respect to the body 102, the brace members 121, 123 will also move pivotally with respect to the body 102. The brace members 121, 123 may alternatively be mounted/secured to a respective strut intermediate of the ends of the strut 122, 124.

The brace members 121, 122 may or may not be transitionally mounted/secured to the body 102. Similarly, the brace members 121, 123 may or may not be translationally mounted/secured to a respective strut.

Although not shown in the drawings at least one pivotable handle may be located at the storage compartment 106 and/or mounted/secured as part of the trundler mechanism 120. The pivotable handle may be able to be moved from the stored condition adjacent/in/parallel the storage compartment 106 and deployed condition extending away and preferably upwards (when the trundler is in use) from the elongate body. The pivotable handle may be able to be locked once in the deployed condition so that it does not return or tend to return back to the stowed condition. Preferably, there may be a button 146 located at the storage compartment lid 106 or any other suitable location which when depressed allows the angle of the pivotable handle, storage compartment lid 108, or both to be adjusted upwards or downwards. Preferably, release of the button 146 causes the angle to be set or locked.

In the deployed condition, the struts 122, 124 may be angled less than 90 degrees (preferably between 30 degrees and 75 degrees) from the elongate body. Similarly, in the deployed condition the brace members 121, 123 may be mounted/secured or adapted to be mounted/secured to the struts 122, 124 in such a way that the angle between the elongate body 102 and each of the brace members 121, 123 are less than 90 degrees. In the deployed condition the elongate body 102 is tilted at an angle preferably at least 40 degrees from horizontal.

In order to retrieve the wheels 132, 134, 136 from the wheel compartment 111, the wheel compartment lid 112 may be opened as shown in FIGS. 2e and 3d thereby revealing the wheel storage compartment 111. The wheels 132, 136, 134 may then be removed from the wheel storage compartment 111. Referring to FIG. 3d, wheel compartment lid 112 may be pivotally mounted to the body 102 and therefore pivotally opened from a closed position to a partially open position 112a and then to fully opened position 112b. Preferably, the wheel compartment lid 112 is pivotable about an axis that is orthogonal to longitudinal axis of the elongate body 102. Once, the wheels 132, 134, 136 have been retrieved, the wheel compartment lid 112 may be moved back to its closed position.

The wheels 132, 134 may be able to be secured to or near each of the distal ends 122b, 124b of the struts 122, 124.

As described previously, the wheel attachment and support mechanism 126 may be in the form of the fork (preferably telescopic fork). This is shown for example in FIG. 2h and FIG. 3e. The wheel attachment and support mechanism 126 and may be moved (preferably pivotally) from a stowed position as shown in FIG. 2c to the extended position as shown in FIG. 2f. The wheel attachment and support mechanism 126 may be configured to moved pivotally from the stored position as shown in FIG. 3c to a partially extended position and then to fully extended position as shown in FIG. 3e.

As shown in FIG. 2b, one of ends which is a proximal end 126a of the wheel attachment and support mechanism may be pivotally mounted to a U-shaped member 180 and the U-shaped member 180 may be mounted/secured to the rails 119a, 119b and the wheel attachment and support mechanism may be formed as a part of the overall trundler mechanism 120. Instead of being mounted/secured with the rails 119a, 119b the U-shaped member 180 may be integrally formed with the rails 119a, 119b. Alternatively, the wheel attachment and support mechanism 126 may be completely separate from the rest of the trundler mechanism 120. Once, into the fully or desired extended position, the wheel attachment and support mechanism 120 may be configured to be locked so that it does not accidently return or tend to return back towards the direction of stowed position.

The rear wheels 132, 134 may be able to be secured to or near each of the distal ends 122ba, 124bb of the struts 122, 124. Similarly, the front wheel 136 may be secured to or near each of the distal end 126b of the wheel attachment and support mechanism 126. This is shown in FIGS. 2g, 2h, 3e and 3f. In this way, the golf club carrier 100 may be deployed as a three-wheel trundler that is supported above the ground and can be easily transported or dragged by the user by pushing it like a normal trolley. The line of roll of the two rear wheels 132, 134 at the back may be on each side of the line of roll of the third or front wheel 136. The line of roll of the front wheel 136 may lie in a plane that also passes through the elongate direction axis of the elongate body 102. The three wheels 132, 134, 136 may contact the ground at three points each at an apex of the notional triangle. As shown, in the deployed condition the elongate body 102 is tilted at an angle from horizontal. Preferably, the three wheels 132, 134, 136 support the body 102 above a horizontal or substantially horizontal surface at an incline of between 40 and 80 degrees to the horizontal or the substantially horizontal surface. Preferably, in use, the rear wheels 132, 134 that are received and secured at the distal ends 122b, 124b of the struts 122, 124 are away from the body 102 more and side of centreline travel direction and the wheel 136 received and secured at the distal end 126b of the wheel attachment and support mechanism 126 is close to the body 102 and preferably on centreline of travel. When in deployed condition, the axis of rotation of the rear wheels 132, 134 mounted/secured to the struts 122, 124 may be coaxial.

The struts 122, 124 and the wheel attachment and support mechanism 126 may have suitable engaging mechanism to facilitate mounting of the wheels. Preferably, the wheels 122, 124 are mounted at or near the distal end of each strut 122, 124. The steps of deploying the carrier 100 into a three wheeled trundler may not be in the exactly the same sequence as described above with reference to FIGS. 2a-2h and 3a-3f

After use, the wheel compartment lid 112 may be moved to the open position, the rear wheels 132, 134 may be easily detached from the struts 122, 124 and front wheel 136 may be easily detached from the wheel attachment and support mechanism 126. The wheels 132, 134, 136 may then be stored back to the wheel compartment 111. After storing the wheels 132, 134, 136, the wheel compartment 111 may then be closed by the wheel compartment lid 112. Similarly, the struts 122, 124 and the wheel attachment and support mechanism 126 may be moved (or pivoted) back to their initial stowed condition and the storage compartment 106 may then be closed with the storage compartment lid 108. If there is any locking mechanism locking the components to a particular position, then the components are first unlocked (or released from the locking mechanism) so that they are easily movable to different position(s).

Therefore, from the above, it can be appreciated that with the use of a slide such as a collar 118, the struts 122, 124 just pivot out from the ends 122a, 124a, but retract back and into the storage compartment 106.

As mentioned above, the storage compartment lid 108 may of a pivotable arrangement (such as by a hinge) as shown in the FIGS. 2a to 2h. Preferably, the storage compartment lid 108 pivotable about an axis that is orthogonal to longitudinal axis of the elongate body 102.

The storage compartment lid 108 may comprise a pocket 140 such as a mesh pocket, solid pocket with hinged solid cover, or both. FIGS. 3a-3e, show the pocket 140 as a mesh pocket. The pocket may be suitable for storage of items such as but not limited to golf balls, wallets, phones, score cards etc. There may be means suitable for holding water or drinks bottle such as a cavity or a recess 143

As mentioned above, the storage compartment lid 108 may also comprise a gripping portion 142 (or handle) that is adapted to facilitate gripping by hand(s) of a user. Preferably, the gripping portion 142 contains the button 146 which when depressed allows the angle of the gripping portion 142 or storage compartment lid 108 or both to be adjusted upwards or downwards. Therefore, the storage compartment lid 108 can double as a handle for pushing, pulling and controlling the direction of the golf club carrier when transported in a rolling manner over the ground. Preferably, release of the button 146 causes the angle to be set or locked. Preferably, the handle can move between a condition parallel the elongate body and a condition for use presented in a position rotated more than 90 degrees from its condition parallel.

Preferably, the compartment lid can move between a condition parallel the elongate body when in the closed position and a condition for use presented as a handle in a position rotated more than 90 degrees from its closed position.

The storage compartment lid 108 comprises a flat surface portion 144. The flat surface portion can allow the golfer to put small items, for example: drinks, snacks, gloves etc. when playing the game.

The storage compartment lid 108 may be rigid or non-rigid such as made out of a fabric.

Instead of being pivotally mounted to the body 102, the storage compartment lid 106 may be temporarily secured onto the second end to the body 102 by a locking mechanism. For example, the storage compartment lid 112 may be secured on to the body 102 by a snap fit mechanism, screwed on, or with a latch etc. The storage compartment lid 112 may even comprise a zip for connecting the storage compartment lid 108 with the body 102.

FIG. 6a-6e show few examples of a removable cover or bag hereinafter referred to as a skin 160 that may be suitable for enveloping or wrapping body of the golf club carrier such as but not limited to the main elongate body 102 of the golf club carrier 100 as described above.

The skin 160 may attach to the golf club carrier, such as carrier 100, using a combination of fastening/attachment mechanisms including but not limited to: zips, Velcro, press studs, clips or a combination thereof. For example, the skin 160 may be attached to the top portion 161 or bottom portion 163. Similarly, the skin may wrap around the body 102 and secure the exterior portion 165 of the storage compartment housing without impeding the trundler mechanism 120.

The skin 160 may be of a flexible construction able to wrap the main elongate rigid body 102, save for at least the first end 101 of the body 102.

The skin 160 may be able to be fastened to at least one of (a) itself and (b) the body 160, to secure the skin 160 to the body.

In one embodiment, the skin 160 may envelop a golf club carrier that comprises an elongate body with a first end and an opposite second end of the body and at least one golf club receiving compartment adapted to receive golf clubs from the first end. The skin 160 may be of a flexible construction able to wrap around the body, save for at least the first end of the body. The skin 160 may be able to be fastened to at least one of (a) itself and (b) the body, to secure the skin 160 to the body. The skin 160 may include an interior to located snugly about the elongate body. The skin 160 may include an interior to locate snugly about the elongate body yet is able to be exposed by a split 169 extending from the top to or towards the bottom of the skin via which the elongate body can enter the skin 160. The split 169 may be able to be closed and preferably includes a closure mechanism to hold the split in a closed condition. The split 169 may allow the skin to peal open to allow for the elongate body to be inserted into the skin in a direction lateral to the elongate direction. The skin 160 may include at least one pocket 161. The pocket may be opened and closed. Alternatively, the skin 160 may include a plurality of pockets. The skin may also include at least one handle 162. The skin 160 may also include an opening for a handle on the elongate body to pass through.

The skin 160 may be able to be manipulated by a user to be on open condition wherein the skin 160 may be presented to receive the body [such as elongate main body 160], and a more closed condition wherein the skin 160 may be wrapped around the body 102 to engage and secure therewith.

The skin 160 may be made from a plurality of panels secured together by bonding or stitching.

The skin may be constructed of a water-resistant material such as but not limited to plastic. The skin may be constructed from many suitable materials such as but not limited to a plastic, vinyl, polyurethane, elastane or a combination thereof.

If the body [such as body 102] of the golf club carrier includes a housing or a storage compartment [such as storage compartment 106] for stowing at least two struts [such as struts 122, 124] to each receive a wheel, the skin 160 may be open or openable when wrapped around the body 102 at/over the housing or the storage compartment or the lid 108 in order allow the struts to project through the skin and away from the main body.

As shown in FIG. 6f, the body such as [body 102 of the golf club carrier 100] may have a channel or groove 167 running the length (or part length) into which a rigid or semi rigid “spine” on the skin 160 could be inserted to provide additional strength/support/stability to the skin 160.

The skin 160 may be made from leather, synthetic leather, nylon, plastic, cotton, polyester, vinyl, polyurethane, elastane or a combination thereof.

If the body comprises a rigid or semi rigid handle then the skin may be designed to attach around the body without concealing such handle (for example: there may be complementary hole in the skin to align over the handle without concealing the handle when the skin 160 is wrapped around the body of the carrier.

As previously described, the golf club carrier 100 may be compartmented into the storage compartment 106 for stowing the trundler mechanism, a golf club storage compartment 108 for receiving and storing golf clubs 117, and a wheel compartment 111 for receiving and storing wheels.

The golf club storage compartment 106 may be configured to extend into the openings 139, 139a of the wheels 132, 134, 136 when the wheels 132, 134, 136 are stored in the wheel compartment 108.

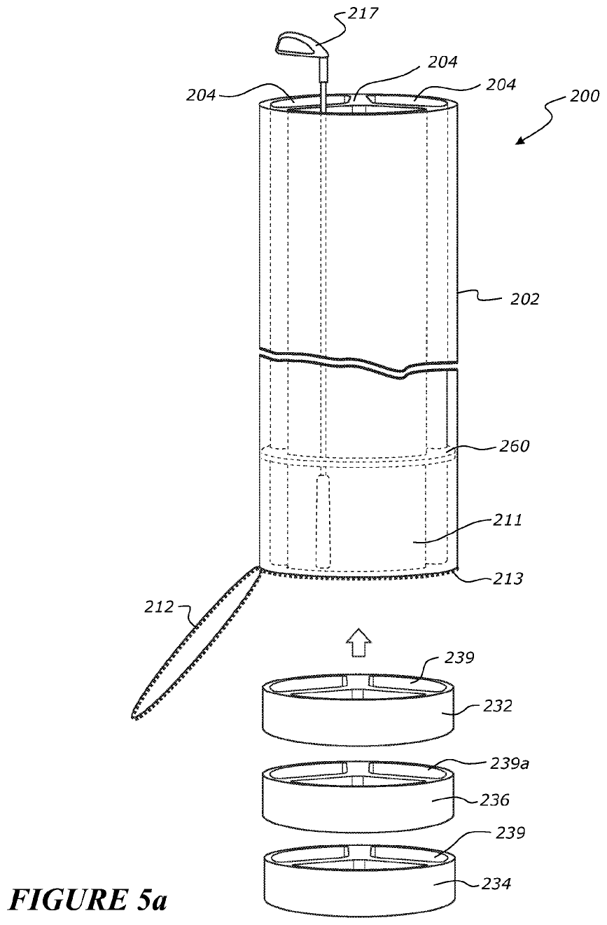

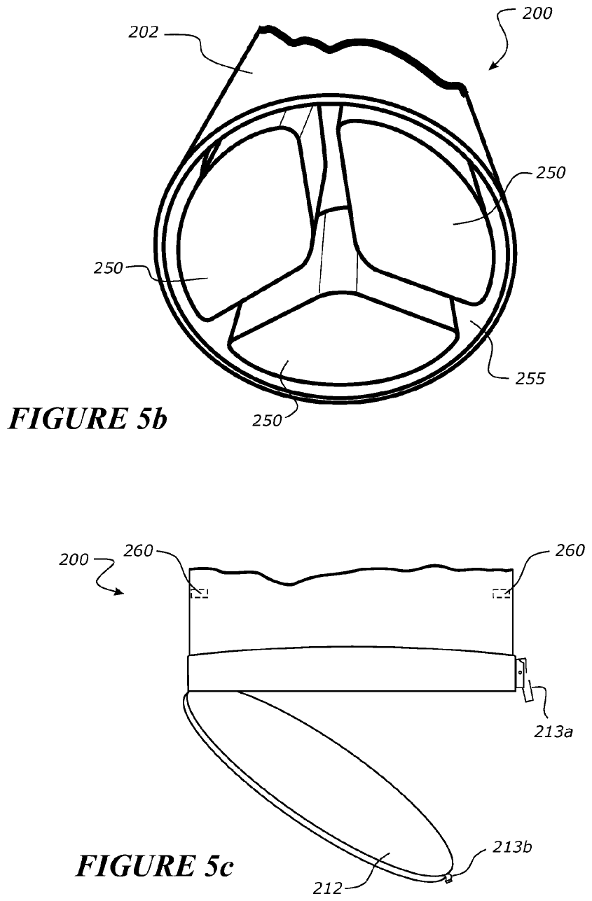

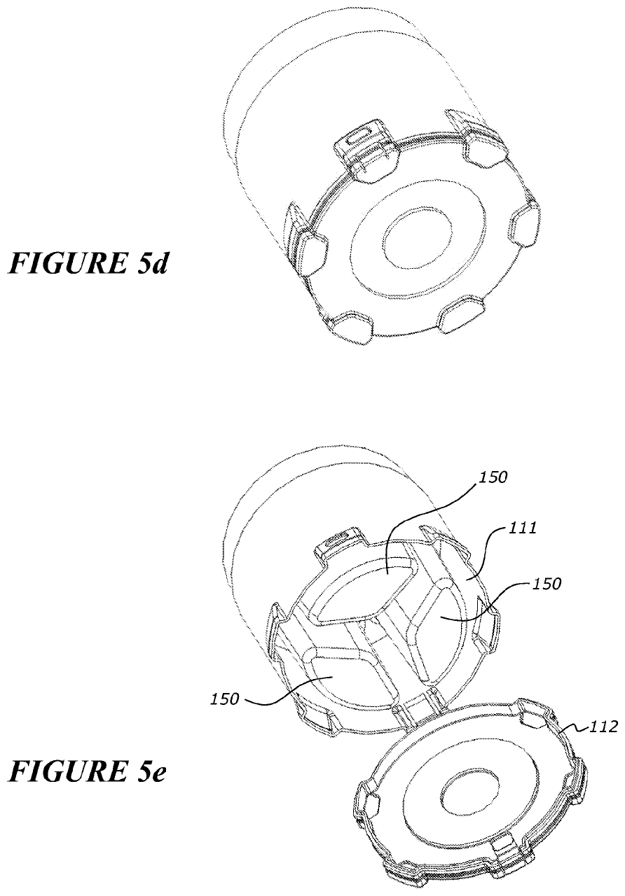

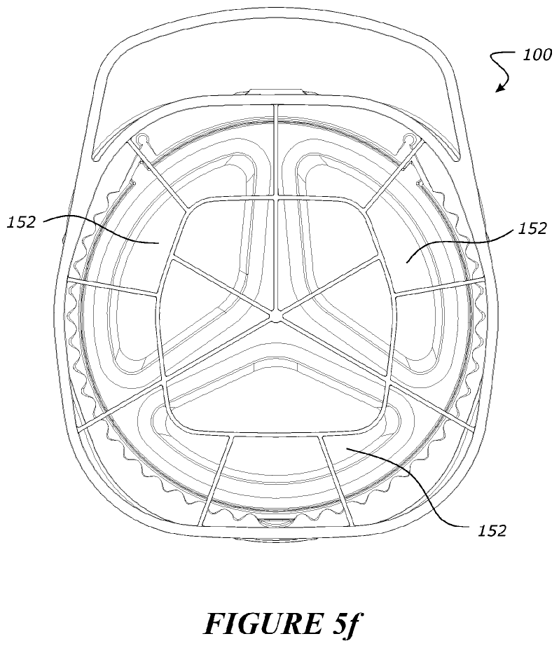

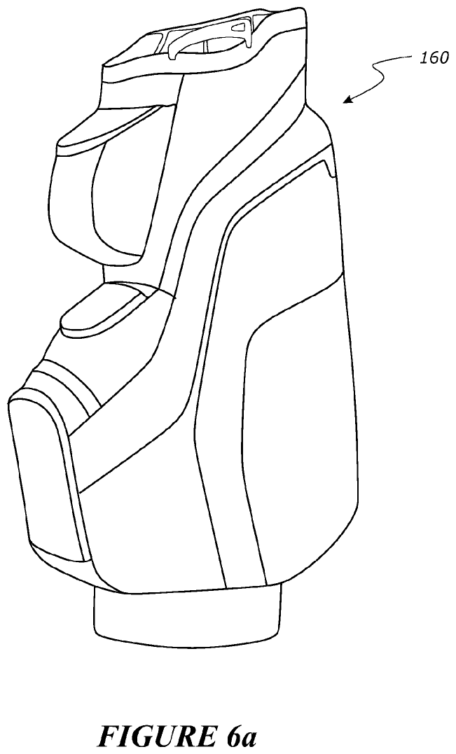

FIG. 5a shows a side view of the golf club carrier 200 according to the second preferred embodiment of present invention which is substantially same as the golf club carrier 100 of the first preferred embodiment as described above. The only major difference is that there are only three golf club receiving compartments 204 in the golf club carrier 200 instead of more than three golf club receiving compartments 104 in the golf club carrier 100. Another difference is this embodiment shown use of zip 213 for opening and closing the wheel storage compartment 211. The shape of the wheel compartment lid 212 of golf club carrier 200 is also different than in that of the golf club carrier 100. The body 202 does not have grooves on the external surface. Apart from these differences, all other description above with reference to the golf club carrier 100 of the first preferred embodiment may equally apply to the golf club carrier 200 of the second preferred embodiment. The wheels 232, 234, 236 may be same as the wheels 132, 134, 136 as described above, which the wheel 232 being substantially the same as the wheel 132, the wheel 234 being substantially the same as the wheel 134 and the wheel 236 being substantially the same as the wheel 134. The storage compartments and the trundler mechanism are not shown in FIG. 5a for the sake of clarity.

FIG. 5b is partial view the golf club carrier 200 showing the wheel compartment 211. The wheel compartment lid 216 is not shown for the sake of clarity.

As shown in FIGS. 5a and 5b, the golf club storage compartment 206 may be formed as a separator 250-the separator 250 being a mechanism that separates the wheels 232, 236, 234 from the golf clubs.

The separator 250 may separate the at least one golf club receiving compartment 204 from the wheel compartment 211. In other words, the separator may be configured to separate stowed golf club 217 (or stowed golf clubs) from stowed wheels 132, 134, 136.

An advantage of separating the golf clubs such as golf club 217 and the wheels 232, 234, 236 from contact is to limit or prevent transfer of mud and grass etc. on the wheels 232, 234, 236 which may have been accumulated during gameplay to the golf club(s) 217. A wheel compartment 211 to separate golf club(s) 217 and wheels 232, 234, 236 may also limit or prevent movement of the stored club(s) 217 and wheels 232, 234, 236 to reduce damage due to the items rubbing against each other or with the body 202.

The separator 250 may be secured to the golf club receiving compartment 204 or to the wheel compartment 211 or both and may be integrally formed with one or both of the compartments 204, 211.

The separator 250 may be of the shape that complements the shape of at least some of the openings 239, 239a of each wheel. In other words, the separator 250 may form a cavity 255 that is complimentary to the profile of the wheels 232, 234, 236. That can allow the separator 250 to project into the one or more through openings 239, 239a of the wheels 232, 234, 236 when the wheels 232, 234, 236 are stored in the wheel compartment 211. The separator 250 may be configured to accommodate at least one golf club 217 in such a manner that a club handle of the at least one golf club 217 can locate in one of the through openings 239, 239a of the at least one of the wheels 232, 234, 236 without coming into contact with the wheels 232, 234, 236. For example, as shown in FIGS. 5a-5b, the separator 250 may form protrusions or pockets that are configured to extending into the openings 239, 239a of the stored wheels to allow an end of the golf clubs 217 to enter through the wheel openings 239, 239a without the golf clubs 217 coming into contact with the wheels 232, 234, 236. The separator 250 may be an extruded or formed as an intermediate layer. The separator 250 may be rigid. As mentioned above and as shown in FIG. 4c, the spokes of the wheels 132, 134, 136 may be aligned when the at least two wheels are coupled together and releasably locked together. That can allow the separator 250 to easily project into the one or more through openings 239, 239a of the wheels 232, 234, 236 when the wheels 232, 234, 236 are stored in the wheel compartment 211 without requiring the user to adjust each individual wheel inside the wheel storage compartment during storage of the wheels in order to ensure that the openings 239, 239a of the wheels are aligned for the separator 250 to project through the openings 239, 239a.

The golf club carrier 100 of the first preferred embodiment of the present invention may also comprise a separator in a similar to the one as described above. FIG. 5e shows one example of how a separator 150 may be formed inside the wheel storage compartment 111 of the carrier 100 of the first preferred embodiment. The separator 150 need not be integrally formed with the golf club receiving compartment 104 and can be a separate part. FIG. 5d shows an example of how the wheel compartment lid 112 may look like from bottom when closed. It is to be noted that FIGS. 5d and 5e are partial views and the features appearing in the external surface of the body 102 are not shown in FIGS. 5d and 5e for the sake of clarity.

As shown in FIG. 5f, the golf club carrier 100 may also comprise a further separator, i.e. top separator 151 at the top portion of the elongate body 102. The top separator 151 is designed to complement the shape of the separator 150 that are in the form of pockets 152 located below so that up to five golf clubs can be guided to into each pocket 152. The golf club carrier 300 may also comprises such further top separator.

The golf club carrier 200 preferably comprises a stopper 260 to prevent the stowed wheels 232, 234, 236 from knocking around within the carrier 200 or travelling up the body 202 during transport. The stopper 260 may be useful to minimise movement of the stowed wheels 232, 234, 236 and to reduce wear and tear of the wheels 232, 234, 236 and the body 202. The stopper 260 may be located part way along the body 202. In one embodiment, as shown in FIG. 5a, the stopper 260 may be complementary to the shape of the wheels 232, 234, 236.

Alternatively, the golf club carrier 200 may comprise a stopper 260 protruding from the inner walls, partially across the body 202 as shown in FIG. 5c. The separator 250 and the stopper 260 may be integrally formed.

The golf club carrier 100 of the first preferred embodiment of the present invention may also comprise a stopper in a similar to the one as described above.

In one embodiment, the golf club carrier 100, 200 may comprise a biasing device (not shown) which supplies a force to the wheels 132, 134, 136, 232, 234, 236 when stored, in the direction towards the base (i.e. towards the wheel compartment lid 112, 212 of the golf club carrier 100, 200. The biasing device may be biased by a biasing means such as spring. The biasing device may push the stowed wheels 132, 134, 136, 232, 234, 236 towards the wheel compartment lid 112, 212 of the carrier 100, 200. The wheels 132, 134, 136, 232, 234, 236 that are biased towards the wheel compartment lid 112, 212 can be advantageous as it can ensure that the golf club carrier 100, 200 has a low centre of gravity, and result in a more stable golf club carrier in a stationary state or when it is being transported. Additionally, the wheels 132, 134, 136, 232, 234, 236 biased towards the wheel compartment lid 112, 212 of the golf club carrier 100, 200 can make accessing the wheels 132, 134, 136, 232, 234, 236 easier from golf club carrier 100, 200. Once, the wheel compartment lid 112, 212 is opened, the wheels will come out easily and the wheels may easily be retrieved using one hand only. Alternatively, the wheels 132, 134, 136, 232, 234, 236 when stored may be biased towards the wheel compartment lid 112, 212 due to gravity only.

The biasing device may be a spring biased magazine. The magazine may preferably be biased towards the wheel compartment lid 112, 212. In such embodiment, a user may enter a one wheel into the wheel compartment 111 and that wheel is biased towards the wheel compartment lid 112, 212. The user can then still insert the further wheels into the wheel compartment 111, 211, pushing the first wheel upwards, and all wheels may be biased towards the wheel compartment lid 112, 212. In a further embodiment, the user may insert more than three wheels into the wheel compartment 112, 212. For example, the user may insert another golfer's wheels into the wheel compartment 112, 212 of his or her golf club carrier 100, 200.

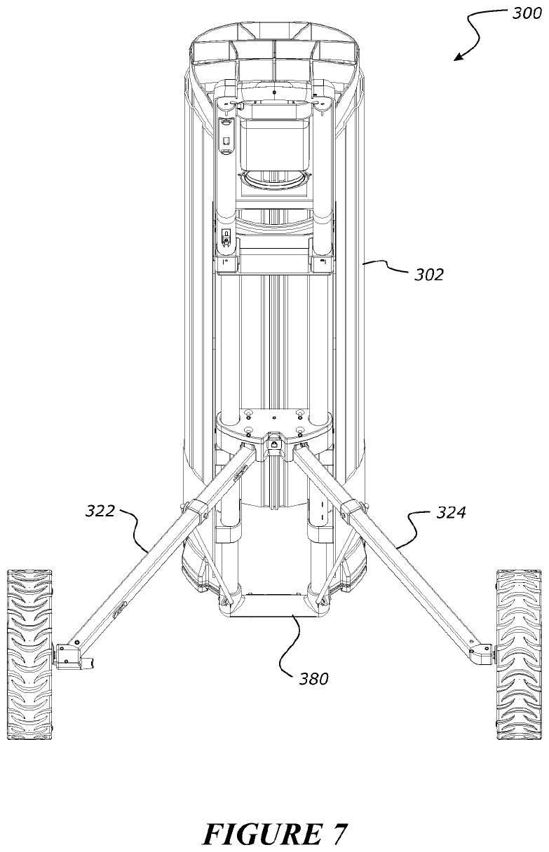

Although, three wheels are most preferred, the golf club carrier 100, 200 may be constructed of only two wheels 132, 134 in which case a wheel attachment and support mechanism 126 as described above may be redundant. FIG. 7 shows a third preferred embodiment of the golf club carrier 300. The only major difference is that unlike in golf club carrier 100 of the first preferred embodiment, the golf club carrier 300 or the trundler mechanism of the golf club carrier 300 of the third preferred embodiment does not have any wheel attachment and support mechanism and the golf club carrier 300 is constructed only of two wheels. All other description above with reference to the golf club carrier 100 of the first preferred embodiment may equally apply to the golf club carrier 300 of the third preferred embodiment.

However, three-wheel trundler is still the most preferred option at least because of much better support and stability and well as for comfort during use.

In one embodiment, the wheel attachment and support mechanism may comprise a small wheel (for example castor wheel or even a slightly larger wheel than a castor wheel) which may be permanently attached to the wheel attachment and support mechanism and during the stowed condition, the wheel attachment and support mechanism together with the front wheel attached may be stored inside the storage compartment. The third or front wheel may be mounted/secured, in use, as an idler wheel.

Instead of one slidable collar 118, it may be possible that the trundler mechanism comprises a respective slidable collar for each rail to slide along the rail(s). In other words, it may be possible that one collar is mounted/secured to each rail 119, 119b. In one embodiment, other suitable slide or slides may be used instead in addition to the collar. In one embodiment, the rails 119a, 119b may be presented on the body as part of the body and the collar 118 may slide along that rails 119a, 119b.

The trundler mechanism 120 may not be limited to the example as described above and that many other suitable mechanisms for extending the struts 122, 124 from the stowed position to the extended position may be used with the golf club carrier 100.

The storage compartment 106 and the storage compartment lid 108 may be optional and it may be possible that that trundler mechanism 102 as described above is permanently attached to the exterior of the body 102 and can be moved between the collapsed/folded position or deployed position in a similar way.

It is also possible that the trundler mechanism 120 is manufactured and sold separately from the golf club carrier 100 so that the trundler mechanism 120 can be permanently assembled the body 100 at a different facility at later stage.

FIG. 10 show a fourth preferred embodiment of the golf club carrier 400 according to the present invention. This embodiment is very similar to the first embodiment of the golf club carrier 100 as described above and therefore only the differences will be described below.

As shown in FIG. 10, elongate body 402 may include at least one handle as an elongate body handle 414 on the exterior surface of the elongate body to assist in lifting the body 402. The handle 414 is preferably integrally formed with the exterior of the body 402. As shown in FIG. 10, the elongate body may have grooves of non-uniform length although such non-uniform length grooves are purely optional. The body of the golf club carriers 100, 200, 300 as described above may also have similar grooves on the exterior surface.

The golf club carrier 400 may further comprises a brake system to slow or stop the golf club carrier.

As shown in 4b, in one example, the brake system may comprise a plurality of holes 135a on its rim. A brake system may comprise a pin that may be adapted to be received by one of the plurality of holes to cause the golf club carrier to slow or stop. Therefore, the brake system may comprise a pin able to engage with part of at least one of said wheels to prevent the wheel from continuously rotating.

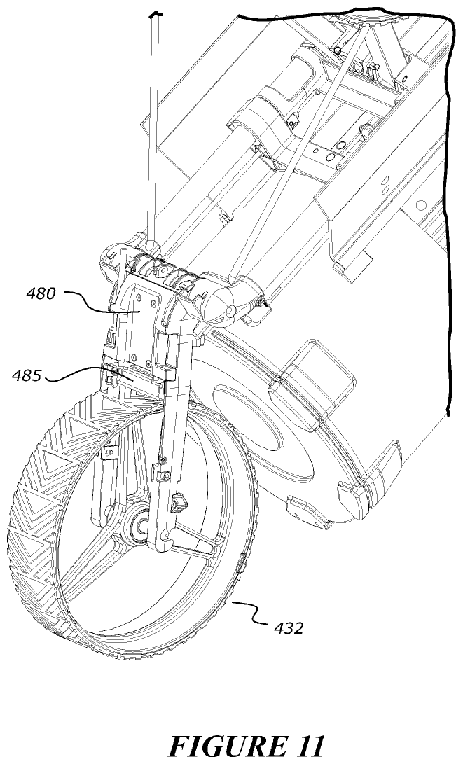

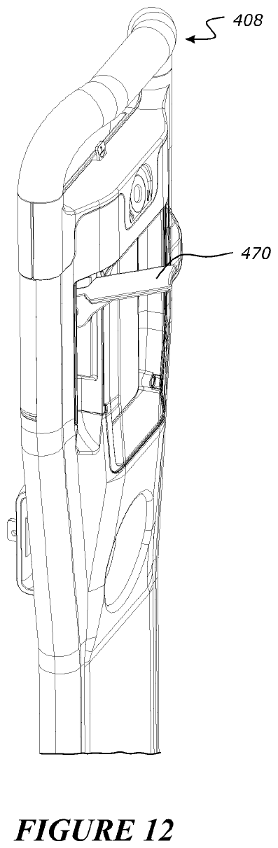

Alternatively or additionally, as shown in FIGS. 10 and 11, the brake system may be a cable brake system comprising a brake handle 470 that is operatively connected to a brake pad 485 by a cable so that when the brake handle 470 is in a first position, for example, a raised position (such as shown in FIG. 12), a tension is caused in the cable allows the brake pad 485 to engage with at least one of the wheels, or with an external tread of said at least one of the wheels thereby causing the golf club carrier to slow or stop

The brake comprises a brake pad 485 may be a flat brake pad that engages the external tread of the front wheel 436 to brake the front wheel.

Preferably, the brake handle 480 is shaped like or presented as a flag as shown in FIG. 12. Preferably, the brake handle is of a colour that is visible from a distance, e.g. red. Preferably, the brake handle 470 is located in the storage compartment lid 408 as shown in FIG. 12.

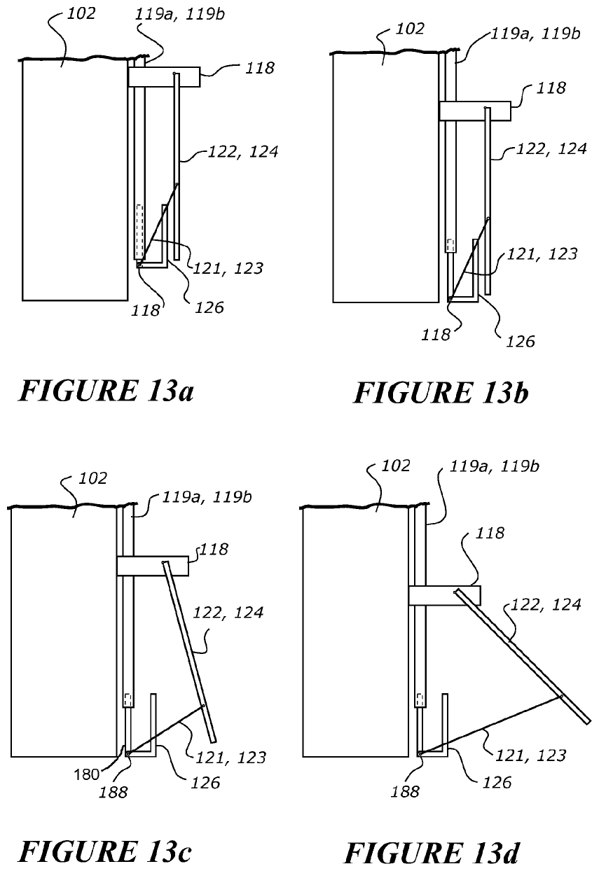

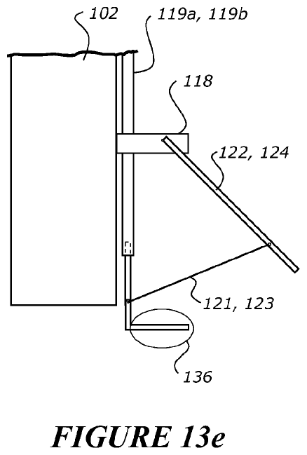

FIGS. 13a to 13d are schematic views sequentially showing the positions of the struts and the brace members when the trundler mechanism transitions from a collapsed or stowed condition to a deployed condition. As shown, one end of the brace member is attached to the strut whose proximal end is pivotally mounted to the collar 118. The other end of the brace member is mounted/secured to a member/secondary slide 180 which may be same as the U-shaped member 180 shown in FIG. 2h. As shown, the member/secondary slide 180 can slide inside and outside the rails 119a, 119b. The wheel attachment and support mechanism 126 is pivotally mounted to the U-shaped member 180. As shown, brace members 121, 123 can force the struts out into their distal position (see FIGS. 13c, 13d) from their proximal position (see FIGS. 13a, 13b) when force is applied downwards on the collar 118. In the position shown in FIG. 13d, the wheel attachment and support mechanism 126 reaches its limit and cannot extend go any further. Therefore, it will be appreciated from FIGS. 13a to 13d that the the downward force on the collar 118 pushes the brace members 121, 123 against the struts 122, 124, forcing the struts 122, 124 outwards into the deployed position/condition. The collar may lock into place in the deployed position/condition shown in FIG. 13d using a suitable lockable mechanism. Preferably, the portion 188 is flat or substantially flat to create stability of the golf club carrier at the base in the deployed position as shown in FIG. 13d.

Each strut 122, 124 may be coupled to the elongate body 102 by the brace member that extends between the elongate body 102 and the strut 122, 124, intermediate of the proximal and distal ends of the strut, so that each strut and respective brace member can move relative the elongate body as a slider crank mechanism.

In one embodiment, each brace member 121, 123 is secured or adapted to be secured to one of the struts with each strut secured or adapted to be secured with one brace member only. In one embodiment, the first end of each brace member 121, 123 is secured or adapted to be secured to one of the struts with each strut secured or adapted to be secured with one brace member only. The second ends of the brace members 121, 123 are secured or adapted to be secured with the or a wheel attachment and support mechanism or the track or secondary slide 180 (which in this example of the preferred embodiment is shown as a U-shaped member) that is slidably mounted to the track to move relative the track in the elongate direction.

As shown in FIG. 2h, the track may be in the form of two parallel spaced apart rails 119a and 119b and the secondary slide 180 is connected to and spans between the two rails. More specifically, as shown in FIG. 2h, the track may comprise two parallel spaced apart rails 119a, 119b and the secondary slide 180 is a U-shaped member telescopically connected to the two rails as ends of the rails proximal the second end 103 of the elongate body 102. The proximal end of each strut 122, 124 is able to translate relative the elongate body 102 and to the second end of the brace that it is secured to, the second end of the brace also able to translate relative the elongate body 102. This is also shown in FIGS. 13a-13d. FIG. 13d shows the front wheel 136 mounted to the wheel attachment and support mechanism 126 when the wheel attachment and support mechanism 126 is pivoted downwards from the secondary slide 180.

Preferably, the brace members are rods or tubes. Preferably, the first end of each of the brace member 121, 123 is secured or adapted to be secured to the struts via fixed or removable securing arrangement and the mounting of the second ends of the brace members 121, 123 are via pivotal, hinged or slidable arrangement.

In one embodiment, the second end of each brace member 121, 123 is pivotally secured to the elongate body. In one embodiment, the second end of each brace member 121, 123 is pivotally secured to the elongate body at or proximate the second end of the elongate body. In one embodiment, the first end of each brace member 121, 123 is pivotally secured to a respective strut 122, 124 intermediate of the proximal and distal end of each strut 122, 124. In one embodiment, the first end of each brace member 121, 123 is pivotally secured to a respective strut proximal the mid-point of each strut. In one embodiment, the first end of each brace member 121, 123 is pivotally secured more proximate the proximal end of a respective strut 122, 124. In one embodiment, the first end of each brace member 121, 123 remains at a fixed distance to the proximal end the strut 122, 124 it is secured to. In one embodiment, first end of each brace member 121, 123 remains at a fixed distance to the distal end the strut 122, 124 it is secured to. In one embodiment, the proximal end 122a, 124a of each strut 122, 124 is able to translate relative the second end of the brace 121, 122 that it is secured to. In one embodiment, the proximal end of each strut 121, 123 is able to translate relative the elongate body 102 and to the second end of the brace member 121, 123 that it is secured to. In one embodiment, there may be only brace member although two brace member are preferred.

In one embodiment, second ends of the brace members 121, 123 are secured or adapted to be secured with the or a wheel attachment and support mechanism 126 or the track 119a, 119b or a secondary slide 180 that is slidably mounted to the track 119a, 119b and/or elongate body to move relative the elongate body in the elongate direction. In one embodiment, the wheel attachment and support mechanism 126 attached to the secondary slide. In one embodiment, the wheel attachment and support mechanism 126 is pivotally attached to the secondary slide. In one embodiment, the wheel attachment and support mechanism 126 translates with the secondary slide as it moves relative the elongate body. In one embodiment, the secondary slide 180 moves between a first and second position relative the elongate body 102, the first position corresponding to the first position of the slide and the second position corresponding to a position of the slide intermediate of its first and second positions. In one embodiment, first and second positions of the secondary slide are defined by stops.

As shown sequentially in FIGS. 3a to 3e, the slide or collar 118 first moves from the first position to the second position and the secondary slide 180 then moves from its first position to second position, keeping the struts 122, 124 proximal to the elongate body. When the secondary slide 180 reaches its second position (shown in FIG. 13b, the movement of the secondary slide 180, stops while the slide 118 continues to move to its second position (see FIG. 13c) whereupon the struts 121, 123 start to move to their deployed condition as the slide is moved towards the secondary slide 180 (see FIGS. 13d and 13e).

Preferably, the slide (collar) 118 first moves from the first position to the second position and the secondary slide then moves from its first position to second position, keeping the separation of the slide and secondary slide the same. Preferably, in the first position of the slide 118, the slide is more proximal to the first end 101 of the elongate body 102 that in its second position. Preferably, in the first position of the secondary slide, the secondary slide is more proximal to the first end 101 of the elongate body that in its second position. Preferably, the secondary slide 180 moves from its first position to its second position, by moving the slide from the first position to the second position of the slide 180.

Some of the advantages of such cable brake system are as follows:
It removes the need for any cable and pin locking mechanism to be attached to one of the struts engaging the rear wheels. This is beneficial as the struts can be uniformly designed and can be extended and retracted easily without a brake cable or mechanism obstructing the rear struts from being deployed.
The raised brake handle 470 indicates to the golfer that the brake 480 is engaged. A problem many golfers face with cart brakes is that the return to their carts after putting and push the cart without disengaging the brake first as they forget that the brake is engaged. The raised break handle 470 may serves as a visual trigger to remind the golfers that the brake 480 is engaged.

The first and second preferred embodiments of the golf club carrier 100, 200 may also comprise the cable brake system (as described above) that utilises a brake handle (as described above) which when raised causes the break pad to engage the external tread of the front wheel 436 to brake the front wheel in the same or similar way as described above.

Some of the advantages of the present invention are as follows:
Carrier can be easily deployed into a three-wheel trundler mechanism.
Less bulky as the trundler mechanism is hidden when stowed inside the storage compartment.
Self-contained storage area for both the wheels and the trundler mechanism.
The carrier combines three (Bag, trundler and wheels) traditional pieces of golf equipment into one.
The Carrier, with a skin attached, resembles a traditional golf bag.
The sliding pivot for the trundler mechanism allows for longer, more stable struts to be employed which in the stowed position would typically come to rest at or passed the bottom of the carrier.
Easily transportable.
Convenient wheel storage.
Removable skin means the exterior look of the carrier can be changed as per the user's choice.

Some of the advantages of a golf club carrier with three-wheel trundler mechanism are:
Better stability/balance due to three wheels
Can be pushed during transportation and therefore causing less shoulder fatigue to golfers and consequently minimise the risk of injury as compared two wheeled golf carts that are typically designed to be pulled.
Can remain at a constant angle when being transported and standing at rest thereby allowing golfers a much convenient way to retrieve and store their clubs whilst playing golf.

It will of course be realized that while the foregoing has been given by way of illustrative example of the present invention, all such modifications and variations thereto as would be apparent to a person skilled in the art are deemed to fall within the broad scope and ambit of the various aspects if invention as is hereinbefore described and/or defined in the claims.

1. A golf club carrier comprising:
an elongate body extending in an elongate direction and having a first end and a second end, the elongate body comprising at least one golf club receiving compartment adapted to receive golf clubs from the first end,
at least two wheels, and
a trundler mechanism attached to the elongate body,
the trundler mechanism comprising:
i. a track extending in the elongate direction;
ii. at least one collar slidably mounted to the track and adapted to slide along the track in the elongate direction of the elongate body between a first position and a second position; and
iii. at least two struts each having a proximal end and a distal end, the proximal ends of each strut being mounted to the collar in a manner to be able to pivot relative to the track; and
wherein the elongate body comprises a wheel compartment located and integrally formed at a bottom region of the elongated body proximal to the second end of the elongate body and configured to store said at least two wheels, the at least two wheels being able to releasably couple together in a co-axial manner for storage inside the wheel compartment, the golf club receiving compartment extends to the wheel compartment,
wherein trundler mechanism is reconfigurable between (a) a stowed condition where each strut is positioned with its distal end proximal the elongate body when the collar is in the first position and (b) a deployed condition when the collar is in the second position where each strut is presented with its distal end more distal from the elongate body than when in the stowed condition in a manner extending from the proximal end away the elongate body, each strut able to receive and secure one wheel of the at least two wheels at or near the distal end of each strut to allow the carrier to be transported in a rolling manner over ground.

2. The golf club carrier as claimed in claim 1, further comprising a storage compartment that is configured to stow the trundler mechanism, the storage compartment being presented adjacent the elongate body, wherein:
in the stowed condition of the trundler mechanism, the struts are positioned to locate in the storage compartment, and
in the deployed condition of the trundler mechanism each of the struts are presented extending, out of the storage compartment, in a manner extending away from the elongate body.

3. The golf club carrier as claimed in claim 1, wherein each wheel has a rim and one of the at least two wheels comprises protrusions formed on at least one side of its rim, the protrusions of said at least one wheel being configured to be received by complementary features formed on the rim of the other of said two wheels for releasable coupling of the at least two wheels.

4.-5. (canceled)

6. The golf club carrier as claimed in claim 1, wherein the wheel compartment is configured to store at least three wheels in a co-axial manner.

7. (canceled)

8. The golf club carrier as claimed in claim 1, wherein the struts are configured to move pivotally relative to the collar when the trundler mechanism reconfigures between the stowed condition to the deployed condition.

9. (canceled)

10. The golf club carrier as claimed in claim 1, wherein the storage compartment is presented adjacent the elongate body on an external surface of the elongate body.

11. (canceled)

12. The golf club carrier as claimed in claim 1, wherein the track comprises two spaced apart and parallel rails and the at least one collar is adapted to slide along the rails between its first and second positions in the elongate direction of the elongate body.

13. The golf club carrier as claimed in claim 1, wherein the at least one collar is configured to lock to the track by a locking mechanism.

14. The golf club carrier as claimed in claim 1, wherein the struts are adjustable in length.

15. (canceled)

16. The golf club carrier as claimed in claim 1, wherein the trundler mechanism further comprises a wheel attachment and support mechanism dependent from the elongate body and having a proximal end and a distal end, the wheel attachment and support mechanism being configured to be move between (a) a stowed condition where the wheel attachment and support mechanism is located more proximal the elongate body and (b) a deployed condition where the wheel attachment and support mechanism is presented in a manner extending from the elongate body with its distal end at a position that is more distal the elongate body than in the stowed condition, and in a manner to be able to receive and secure a wheel that, in cooperation with the first and second wheels, allow the carrier to be rolled over ground.

17. The golf club carrier as claimed in claim 16, wherein
(a) in the stowed condition of the wheel attachment and support mechanism, the wheel attachment and support mechanism is positioned proximal the elongate body and located in the storage compartment, and (b) in a deployed condition of the wheel attachment and support mechanism, the wheel attachment and support mechanism is presented in a manner extending away from the elongate body with its proximal end at the storage compartment and its distal end at a position that is more distal the storage compartment and elongate body than in the stowed condition.

18. The golf club carrier as claimed in claim 16, wherein the wheel attachment and support mechanism comprises a fork comprising two spaced apart and parallel arms and the at least one wheel is able to be received and secured between the two arms of the fork.

19. The golf club carrier as claimed in claim 16, wherein the golf club carrier is configured to be supported above the ground by three wheels and wherein the three wheels comprises two rear wheels configured to be received and secured by the struts and a front wheel configured to be received and secured by the wheel attachment and support mechanism.

20. (canceled)

21. The golf club carrier as claimed in claim 1, wherein the golf club carrier further comprises a brake system to slow or stop the golf club carrier rolling over ground.

22.-26. (canceled)

27. The golf club carrier as claimed in claim 1, wherein the trundler mechanism further comprises at least two brace members, each brace member having a first and second end, the first end of each brace member is pivotally secured to a respective strut and the second end of each brace member is pivotally secured relative the elongate body.

28. The golf club carrier as claimed in claim 1, wherein each strut is coupled to the elongate body by a brace member that extends between the elongate body and the strut, intermediate of the proximal and distal ends of the strut, so that each strut and respective brace member can move relative the elongate body as a slider crank mechanism.

29. The golf club carrier as claimed in claim 1, wherein the trundler mechanism comprises at least two brace members, each brace member being secured or adapted to be secured to one of the struts with each strut secured or adapted to be secured with one brace member only.

30. (canceled)

31. The golf club carrier as claimed in claim 29, wherein a first end of each of the brace members is secured or adapted to be secured to the struts via fixed or removable securing arrangement and the mounting of the second ends of the brace members are via pivotal, hinged or slidable arrangement.

32.-38. (canceled)

39. The golf club carrier as claimed in claim 1, wherein the elongate body comprises a wheel compartment lid that is pivotally mounted to the elongate body which when closed substantially or fully encloses the wheel compartment at the bottom region, and which when open reveals the wheel compartment thereby providing access to the storage compartment from the bottom region.

40. A trundler mechanism attached to a golf club carrier, the golf club carrier comprising:
an elongate body extending in an elongate direction and having a first end and a second end, the elongate body comprising at least one golf club receiving compartment adapted to receive golf clubs from the first end, wherein the elongate body comprises a wheel compartment integrally formed and located at a bottom region of the elongated body proximal to the second end and configured to store at least two wheels of the golf club carrier, the at least two wheels being able to releasably couple together in a co-axial manner for storage inside the wheel compartment, the golf club receiving compartment extends to the wheel compartment,
the trundler mechanism comprising:
i. a track;
ii. at least one collar slidably mounted to the track and adapted to slide along the track in a direction parallel to the elongate direction of the elongate body between a first position and a second position; and
iii. at least two struts each having a proximal end and a distal end, the proximal ends of each strut being pivotably mounted to the collar; and
iv. at least one brace member for each strut extending between and in a pivotal manner relative to each strut and the elongate body,
wherein trundler mechanism is reconfigurable between (a) a stowed condition where each strut and respective brace member are more parallel each other and to the elongate direction than when in a deployed condition where each strut and respective brace member are less parallel each other and to the elongate direction.
